(19) United States
(12) Patent Application Publication
(10) Pub. No.: US 2025/0241316 A1
(43) Pub. Date: Jul. 31, 2025

(54) SURFACE TREATMENT COMPOSITION COMPRISING BOTH CHEMICAL AND MICROBIAL COMPONENTS FOR SURPRESSING NON-GRAS MICROORGANISMS ON A SURFACE, TO THE BENEFIT OF GRAS MICROORGANISMS

(71) Applicant: Alan D. Pulman, Gwynedd (GB)

(72) Inventors: Alan D. Pulman, Gwynedd (GB); Thomas Meneghini, Memmingen (DE)

(73) Assignee: Alan D. Pulman, Gwynedd (GB)

(21) Appl. No.: 19/036,546

(22) Filed: Jan. 24, 2025

Related U.S. Application Data
(60) Provisional application No. 63/625,445, filed on Jan. 26, 2024.

(51) Int. Cl. A01N 63/22; A01N 25/32; A01P 1/00

(52) U.S. Cl. CPC A01N 63/22; A01N 25/32; A01P 1/00

(57) ABSTRACT

A rehabilitation composition includes: a micellar water including one or more non-ionic surfactants which are soluble or emulsifiable or dispersible in water; one or more of a prebiotic, a probiotic, or a postbiotic; one or more excipient solvents; one or more excipient pH regulators, one or more excipient acids or their alkali and/or alkaline earth salts and/or amino acids giving the resulting composition a pH between 3 and 4.2; and up to 98.695% by weight of water. An aqueous liquid composition of the rehabilitation composition includes the one or more non-ionic surfactants in an amount ranging from 1.0 to 5.0% by weight; no surfactants other than the non-ionic surfactants are present; the one or more solvents in an amount ranging from 0.1 to 20.0% by weight; no C₁-C₆ alcohols other than a type of glycol ether are present; and no quaternary ammonium compounds are present.

### CROSS REFERENCE TO RELATED APPLICATIONS

This is a non-provisional application based on U.S. Provisional Patent Application Ser. No. 63/625,445 entitled “SURFACE TREATMENT COMPOSITION COMPRISING BOTH CHEMICAL AND MICROBIAL COMPONENTS FOR SUPPRESSING NON-GRAS MICROORGANISMS ON A SURFACE, TO THE BENEFIT OF GRAS MICROORGANISMS” filed on Jan. 26, 2024, which is incorporated in its entirety herein.

### BACKGROUND OF THE INVENTION

### 1. Field of the Invention

The present disclosure is directed to a composition for the rehabilitation of diverse but connected microbiomes. In its application, it reduces non-GRAS (Generally Regarded As Safe) microorganisms and at the same time inoculates GRAS microorganisms within and into the microbiome of a living surface.

### 2. Description of the Related Art

Biocidal compositions, for example disinfectants, are known to act directly on harmful (this is different to non-Generally Regarded As Safe) organisms killing or repelling them and also preventing damage. Harmful organisms are living or non-living organisms that are undesirable or detrimental predominately to humans, animals, however may be required or important to the wider environment t. Harmful organisms may also sometimes be referred to as “pathogens.”

Biocidal compositions have a wide range of applications. They can, for example
be used in nursing care;
in the medical sector, especially in hospitals or doctors' surgeries;
in the public sector, e.g. in schools, swimming pools and sports facilities;
in the private sector, e.g. in cosmetics or in the household;
in arable farming, pasture farming and animal husbandry; or
in water disinfection.

The possible applications are very diverse in each area and relate to the biocidal or disinfecting effect on parts of objects, e.g. individual surfaces, or the objects as a whole, such as surgical instruments, on foodstuff, e.g. water disinfection, on plants, e.g. as wood preservatives, and on animal and human skin, e.g. for the prevention of diseases. Biocides have been subject to an authorisation procedure for several years. The use of individual products can be restricted to certain groups of people, such as specially qualified persons. This disclosure provides an alternative approach to these applications one of rehabilitation of the surface biome not destruction or partial destruction. The composition for rehabilitation is different in all the important aspects; it has no ingredients that constitute an active ingredient which is required for a biocidal product registration (no single ingredient or group of ingredients) effective in less than 48 hours. It is a collection of effectants that are selectively effective or ineffective.

Although the disinfectant effect itself has been known for over 170 years, the exact mode of action has not been clarified in all details. For a long time, it was assumed that disinfectants and antiseptics have a non-specific effect, in contrast to antibiotics, which have a targeted effect and, for example, attack specific cellular targets within the microorganism. Elucidating the virus-killing effect and the exact mechanism of action of a biocide against viruses is generally more difficult to carry out than for bacteria. According to a review article by P. Maris (P. MARIS, in “Modes of action of disinfectants”, Rev. sci. tech. Off. int. Epiz., 1995, 14(1), 47-55)), it was stated that research over the past 30 years has shown that 2 factors in particular are important regarding the susceptibility of viruses to chemical agents: it was found that the presence of lipids in a virus is uniformly associated with high susceptibility to all biocides or disinfectants and the absence of lipids and a small size are therefore associated with resistance to lipophilic chemical agents.

Biocides, such as disinfectants, can act on microorganisms in various ways: e.g. by denaturing action, whereby protein-containing structures of microorganisms are altered and ultimately destroyed, or damage occurs to lipid membranes, for example the envelope of viruses or the nucleic acids of germs or e.g. by growth inhibition, such as bacteriostasis, fungistasis, inactivating or killing effect. In the case of biocidal action or disinfection, the focus is on the killing effect. In contrast, the rehabilitation composition works with a number of chemical keys to create a disinfectant effect.

Biocides are particularly effective against bacteria, viruses, fungi, insects and the like, and therefore have bactericidal, virucidal or virus-inactivating, fungicidal, particularly leuvoricidal and insecticidal activity. A biocidal or disinfectant effect means, in particular, a reduction in germs, which is tested, for example, in a defined test procedure, whereby germs capable of reproduction, i.e. so-called colony-forming units per gram (CFU/g), are examined and the reduction in germs is observed.

Furthermore, it is normally expected that strong or highly effective biocides can damage not only the surface to which they are applied but also the skin of the person handling the composition; this is due to strong oxidising agents or protein denaturing agents which can irritate (activate the skin's defense mechanisms) or damage sensitive or cracked skin tissue, as well as reducing the variety and quantity of commensal microorganisms on the surface. Less effective or weak acting biocides are not focused precisely on the job they are targeted to do—as say an antibiotic, fungicide, or herbicide would do-they are just weaker. This example is particularly relevant to embodiments of the present application in providing a consistent formula base across farms, soils, plants, livestock, surfaces to food processing plants to hospitality establishments to household. With the need to not present a hazard at any level, using appropriate GRAS components for a region.

Highly effective biocides, especially strong disinfectants, can also have adverse effects on the environment. For example, phenols, which are contained in many biocides, have an ecotoxic effect on water and also destroy bacterial species that are important for the purification effect in waters. Many biocides are corrosive, irritate the skin and/or mucous membranes, are flammable or even explosive, or can release toxic chlorine gas when mixed with other household cleaners. Furthermore, toxic and carcinogenic biocides are known, which can also trigger allergies.

The major disadvantage of many highly effective biocides is that they not only kill germs, but do so indiscriminately, without making a distinction between bacteria that are necessary for a healthy microbiome and bacteria that belong to pathogens. The term “microbiome” here refers quite generally to the totality of all microorganisms that occur on earth, in the waters, in the atmosphere, in our environment and on and in our bodies. The microbiome in the actual and narrower sense is understood as the totality of all microorganisms, such as fungi, yeasts, archaea, viruses and mainly bacteria, which colonise all surfaces, especially the entire body surface of humans or other living beings.

For example, human skin is colonised by various bacteria. Some of these bacteria are known pathogens, such as Pseudomonas Aeruginosa and Candida Albicans, while others such as Bacillus subtilis are known for their benefits to human and animal health but in the wrong place they themselves cause illness. A healthy human microbiome is of great importance and supports, for example, digestion or contributes to a good functioning of the immune system. It is well known that an intact microbiome on the skin and on the surface where humans and animals live is conducive to a healthy life. In animal husbandry, for example, it is common practice to colonise surfaces with Bacillus subtilis and Bacillus licheniformis after disinfection, so that the animals can lead a healthier life.

In recent years, a lot of research has been undertaken to analyse the human microbiome in order to support and promote human health when using cosmetics or skin disinfectants. At present, however, it is common practice to focus only on removing pathogens, but this regularly results in the destruction of the existing microbiome when biocide or disinfectant standards are met. However, a microbiome that remains intact would have great benefits for humans and animals. Therefore, a great interest in biocidal agents exist that not only kill or inactivate harmful organisms such as bacteria, viruses, fungi, yeasts and the like, but are nevertheless skin-compatible or even skin-friendly. Within the European Union (EU), the marketing of a biocide as having positive health benefits, is never allowed. So, for example, a skin disinfectant that by the standards given for cosmetics would be dermatologically excellent and anti-aging is contrary to being a biocide.

Microbiomes are a delicate, natural and ever-shifting collections of microorganisms of which only a fraction of a percent are known. These play a role in bacterial balance and health in general. Probiotics, prebiotics and postbiotics are often mentioned in this context. Probiotics (mostly soil based organisms) are a group of “good” bacteria, or microorganisms, that feed off prebiotics (mainly food sources appropriate to the bacteria and environment) producing metabolites known as postbiotics.

An intact microbiome appears to have numerous benefits: for example, it helps to maintain and preserve the skin's moisture barrier and can strengthen the skin's natural defences. The topical application of prebiotics, for example, has a different effect on the skin than oral intake via dietary supplements or food.

In addition, efforts are constantly being made to improve biocidal compositions, such as disinfectants, and especially their application. For example, food companies in the EU must adhere to the HACCP principles. The HACCP principles are also applied in Great Britain and the USA. HACCP stands for “Hazard Analysis and Critical Control Points”. This is a standardised procedure in which safety risks in the production of food are analysed and controlled. An HACCP colour system is part of the food regulation. This colour system, also known as colour coding, is not only used in the food sector, but also in medical and cosmetic sectors, such as hospitals, for cleaning equipment, infection control and generally to prevent the spread of bacteria and is an effective solution to reduce, for example, cases of cross contamination. It is therefore desirable that a biocide based on the HACCP colour system is applicable as supporting simplified standard operation procedures and audits reduces education requirements and reduces non-compliance.

There are numerous proposals for biocides or disinfectants in the prior art.

For example, PCT-application WO 2022/223573 A is directed to a disinfectant comprising an organic acid selected from the group consisting of citric acid, lactic acid and succinic acid, or a mixture thereof; a benzoate selected from the group consisting of sodium benzoate, potassium benzoate or calcium benzoate, or mixtures thereof; one or more surfactants selected from the group consisting of non-ionic surfactants and/or amphoteric surfactants which are soluble or emulsifiable or dispersible in water; and the disinfectant is present in aqueous liquid composition or solid composition, wherein an aqueous liquid composition of the disinfectant contains the one or more non-ionic surfactants in an amount ranging from 1.1 to 3% by weight and/or contains the one or more amphoteric surfactants in an amount ranging from 1.1 to 30% by weight, with the proviso that no surfactants other than the non-ionic and/or amphoteric surfactants are present, no C1-C3 (iso)alcohols are present and the compounds chlorhexidine digluconate, sorbitan caprylate and phenoxyethanol are not present.

Furthermore, reference is made to DE 10 2015 113 641 A1. The DE application describes a disinfectant for the disinfection of inanimate surfaces containing
0.1-10% by weight of at least three organic acids or salts thereof selected from the group consisting of acetic acid, propionic acid, tartaric acid, benzoic acid and lactic acid,
a solvent, water, and
optionally solubilisers selected from glycols, glycol ethers or a mixture thereof, whereby the quantities are in each case related to the total quantity of the application solution. The disinfectant may be present as a liquid aqueous solution or solid concentrate. The disinfectant may contain non-ionic surfactants, cationic surfactants, amphoteric surfactants or a combination thereof as excipients. The liquid concentrates are used in diluted form as disinfectants. It was stated in DE 10 2015 113 641 A1 that no antimicrobial effect is attributed to the non-ionic surfactants, as evidenced by comparative tests. This is completely contrary to the teaching of the present invention.

Furthermore, a proposal for a sanitizing composition for restoring skin's natural balance of bacteria has become known from U.S. Pat. No. 11,564,879 B2. The composition comprises: from about 0.005 wt. % to about 15.0 wt. % of an active ingredient selected from the group consisting of one or more strains of Lactobacillus, Clostridia, Saccharomyces, Lactococcus, Pedicoccus, Enterococcus, Escherichia, Alcaligenes, Corynebacterium, Bacillus, Propionibacterium, and combinations thereof; at least one polymeric thickener; at least about 50 wt. % of one or more ingredients with a sanitizing effect, the one or more ingredients with a sanitizing effect comprising alcohol, a quaternary ammonium compound, or a combination thereof; and up to about 30 wt. % water, wherein the sanitizing composition reduces pathogen binding on skin by a statistically significant amount, as compared to an otherwise identical sanitizing composition without the active ingredient. An extraordinary variety of possible ingredients with sanitizing effect is disclosed, such as one or more C1-8 alcohols, for example, methanol, ethanol, propanol, pentanol, hexanol, and isomers and mixtures thereof, which may be present at up to 70% by weight in the sanitizing composition. Such alcohols are not used according to the present invention. Mention is also made of organic acids such as citric acid, lactic acid, hypochlorous acid, caffeic acid, and the like. Optional ingredients may also include a surfactant such as an anionic surfactant, a cationic surfactant, or a non-ionic surfactant, one or more skin conditioners, such as humectants or moisturisers, emollients, and the like. The sanitizing composition achieves at least a 2-log reduction in the number of viable microorganisms in vitro after 60 seconds according to the ASTM E2783 11 (2016) time kill test method. A 2-log reduction in the number of viable microorganisms is not considered sufficient.

Therefore, what is needed in the art is a way to overcome the deficiencies of the prior art and to provide a generally regarded as safe and effective alternative to supplement biocidal compositions that has the equivalent of a strong biocidal effect, acts very fast, at the same time has a broad spectrum of activity, which attacks essentially only harmful organisms as selectively as possible and has a positive effect on the treated surface after biocidal treatment and supports and promotes the natural microbiome present. In addition, the solution should only contain environmentally compatible components and no strong oxidising agents, such as chlorine or hydrogen peroxide.

### SUMMARY OF THE INVENTION

In some embodiments disclosed herein, there is provided a rehabilitation composition comprising or consisting of one or more acids or their alkali and/or alkaline earth salts; optionally one or more benzoates; one or more non-ionic surfactants which are soluble or emulsifiable or dispersible in water; one or more selectively active/inactive effectants; one or more of a prebiotic, probiotic and postbiotic; and up to 98.695% by weight water. An aqueous liquid composition of the rehabilitation composition comprises the one or more non-ionic surfactants in an amount ranging from 1.0 to 5.0% by weight; with the proviso that no surfactants (0.0% by weight) other than the non-ionic surfactants are present, in particular no anionic surfactants, no cationic surfactants and no amphoteric surfactants. In addition, no quaternary ammonium compounds (0.0% by weight), in particular no quaternary ammonium chlorides (0.0% by weight), are present either.

In some embodiments provided according to the invention, a method of treating a surface with a rehabilitation composition includes: applying the rehabilitation composition to the surface. The rehabilitation composition comprises or consists of: a micellar water comprising one or more non-ionic surfactants which are soluble or emulsifiable or dispersible in water; one or more of a prebiotic, a probiotic, or a postbiotic; one or more excipient solvents; one or more excipient pH regulators, one or more excipient acids or their alkali and/or alkaline earth salts and/or amino acids giving the resulting composition a pH between 3 and 4.2; and up to 98.695% by weight of water. The rehabilitation composition comprises the one or more non-ionic surfactants in an amount ranging from 1.0 to 5.0% by weight; and with the proviso that no surfactants (0.0% by weight) other than the non-ionic surfactants are present; the one or more solvents in an amount ranging from 0.1 to 20.0% by weight; and that no C1-C6 alcohols (0.0% by weight) other than a type of glycol ether are present; and no quaternary ammonium compounds are present.

### DETAILED DESCRIPTION OF THE INVENTION

### Definitions

Terms not specifically defined herein should be given the meanings that would be given to them by a person skilled in the art in light of the disclosure and the context.

In the context of the present invention, the term “biocide” is understood to mean a chemical compound which inactivates, repels or kills harmful organisms. This can take place via a wide variety of mechanisms of action. For example, it can affect and paralyse the nervous system or impair the ability of harmful organisms to reproduce. “Harmful organisms” are living beings that are undesirable or harmful to humans, animals or the environment. These are, for example, pests, such as insects or algae, or microorganisms, such as fungi, yeasts, bacteria or viruses. Widely used biocidal active ingredients in disinfectants are isopropanol, n-propanol, and quaternary ammonium compounds. None of these compounds are used according to the invention.

A “disinfectant” is a chemical compound that activates or kills harmful microorganisms. A “disinfectant effect” here means a reduction in germs, which is checked in a defined test procedure, whereby germs capable of reproduction, i.e. so-called colony-forming units per gram (CFU/g) are examined and a reduction in germs is observed. Areas of application are, for example, hygienic and surgical hand disinfection, skin disinfection or antisepsis, surface, instrument, laundry and room disinfection, water disinfection and the disinfection of waste. Newly approved hand disinfectants are considered biocides under EU law and are only approved as such.

The term “aqueous liquid rehabilitation composition” means that the rehabilitation composition contains water as the main constituent. This may be present, for example, in a proportion of at least 90% by weight, based on the total weight of the rehabilitation composition. The term “liquid” is to be understood in this context as meaning that the main phase of water is liquid, but that solid constituents may also be present distributed in the liquid, so that a dispersion is present, for example.

The term “probiotic” or “probiotics” (“pro” from Latin means “for” and “biotikos” comes from Greek and means “belonging to life”) represents a preparation containing living microorganisms that are either already present as part of the normal microbiome and/or have a positive effect on human, animal and/or plant health. According to the World Health Organization (WHO), these are microorganisms that exert a health effect on a host as soon as they are actively supplied in large numbers. Probiotics are known, for example, as additives in food, e.g. probiotic yoghurt, or as food supplements. The benefits of probiotics can come from the probiotics themselves or from the by-products of bacterial growth.

The term “prebiotic” or “prebiotics” (“pre” as a prefix in foreign words means “before” and “biotikos” comes from Greek and means “belonging to life”) are indigestible substances contained in or added to food that are based on long-chain hydrocarbons. These are, for example, dietary fibres or starches. Prebiotics include, for example, di-, oligo- and polysaccharides such as saccharose, lactose, maltose, trehalose, cellobiose, inulin, lactulose, lactinol, raffinose, stachyose, as well as fructans, oligofructose, starch, and the like; human digestive enzymes cannot metabolise these compounds, i.e. break them down. After oral intake, prebiotics serve, for example, to selectively promote the growth and/or activity of certain desirable germs in the large intestine, so that their multiplication can prevent the colonisation of pathogenic bacterial strains. Along with probiotics, prebiotics are among the most common food additives. A combination of probiotics with prebiotics is called a synbiotic.

The term “postbiotic” or “postbiotics” (“post” as a prefix means “after” and “biotikos” from Greek and means “belonging to life”). These are inactivated bacteria, also known as bacterial lysates or bacterial ferments, or metabolic products of probiotica. The metabolic products are, for example, short-chain fatty acids such as butyric acid, propionic acid or acetic acid, peptides, polysaccharides and enzymes. Some examples of bacterial lysates or bacterial ferments are a ferment of Bacillus coagulans, Lactobacillus ferment, Lactobacillus lysate and Bifidobacterium lysate.

The expressions “comprising”, “comprise”, “comprised”, “containing”, “contain” or “contained” shall also encompass the more specific term “consisting of” or “consist of” unless otherwise stated or apparent from the context.

In addition, it should be noted that in this disclosure, the singular and plural forms are not used in a restrictive manner. As used herein, the singular forms “a”, “an”, “one” and “the” therefore refer to both the singular and the plural, unless otherwise stated or apparent from the context.

The expression “about” or “approximately” means within 10%, which includes particularly within 5% and more particularly within 1% or within 0.1% of a value specified or an upper or lower range value as indicated.

The expressions “Generally Regarded As Safe” and “GRAS” are inferred in the following manner: globally as a base it would include The Classification, Labelling and Packaging (CLP) Regulation ((EC) No 1272/2008) is based on the United Nations' Globally Harmonised System (GHS), which is then supplemented by further restriction on products that could present a hazard to the environment, human food chain, human, and animal health if percentages within compositions are exceeded. This term is used to reflect that the application around the world may lead to different formulations according to the invention in different countries and jurisdictions around the world and so can only be evaluated at the time of use for a product. In other words, “GRAS” is a term that may vary depending on a country's specific laws and regulations but generally corresponds to a composition that presents little, if any, known danger to humans.

### Embodiments Provided According to the Invention

In the following, embodiments provided according to the invention are described in detail without restricting the present invention to these embodiments.

Whilst investigating a weak disinfectant formula for use as a rehabilitation composition comprising or consisting of one or more acids or their alkali and/or alkaline earth salts, one or more benzoates, one or more non-ionic surfactants which are soluble or emulsifiable or dispersible in water, whereby the one or more non-ionic surfactants are present in an aqueous liquid composition of the rehabilitation composition in an amount ranging from 1.0 to 5.0% by weight; one or more moisture control agents, one or more of a prebiotic, a probiotic and a postbiotic; and up to 98.695% by weight water was found to provide a significantly enhanced biocidal, in particular disinfectant, effect. In addition, a selective effect was found to be achievable.

Experiments have shown that not only is a particularly high efficacy of the rehabilitation composition obtained, but also the effect occurs in an unexpectedly short time. This is of great importance in order to obtain a biocidal, especially disinfectant, effect as quickly as possible. In fact, for the rehabilitation composition, the complete development of the disinfecting effect within 30 s was found in experiments. The germicidal rate is probably increased to an unexpectedly high degree by the addition of non-ionic surfactant(s) and the active/inactive effectant(s). It was also found that the pH was a contributing factor in that even less acidic pH levels were more effective against microorganisms since the chemistry appeared more stable. Further, the surface recovery was quicker, and in some way affected the organisms as well. This can significantly reduce the amount of acid(s) used. Despite the very short exposure time, the germ load is significantly reduced. Tests confirm that the rehabilitation composition according to the invention shows an outstanding effect, for example, against the typical environmental bacteria Enterococcus hirea, Escherichia coli, Pseudomonas aeruginosa, Staphylococcus aureus and/or Pluralibacter gergoviae, whereby the germ load or the germ content can be significantly reduced after an exposure time of the rehabilitation composition of just 9 seconds; in certain circumstances, for certain microorganisms, similar to 85% ethanol or 70% isopropanol

In this context, reference is also made to the experiments from International Patent Application No. WO 2022/223573 A1, the disclosure of which is incorporated in its entirety by reference in the following disclosure, and formulas have been prepared that are relevant for comparison to WO 2022/223573 A1; except EN 1275 testing is not repeated as these are to proprietary standards (they are fungicidal test) and is instead replaced with a time to kill test based on ASTM E2315. And so comparisons to the examples of WO 2022/223573 A1 are possible.

The following test plates were used:
Standard Bacteria plate=results at 9 s
300 s, 120 s, 60 s, 30 s, 15 s, 9 s
Pseudomonas aeruginosa NCTC 13359
Staphylococcus aureus NCTC 10788
Escherichia coli NCTC 10418
Enterococcus hirae NCTC 13383
Plate tests Standard Candida plate=at 15 seconds
300 s, 120 s, 60 s, 30 s, 15 s, 9 s
Candida Albicans NCPF 3179
Plates tested mixed food plate=at 9 seconds
300 s, 120 s, 60 s, 30 s, 15 s, 9 s
Pseudomona aeruginosa NCPC 13359
Escherichia coli NCTC 10418
Staphylococcus aureus NCTC 10788
Listeria monocytogenes NCTC 10527
Salmonella enteritidis NCTC 12964
Klebsiella pneumoniae (CRE) NCTC® 13442
Enterococcus faecium
Clostridium perfringens
Skin Fungi plate=at 9 seconds
times—1800 s, 900 s, 300 s, 120 s, 60 s, 30 s
Malassezia furfur ATCC 14521
Skin Bacteria +ve Plate
Staphylococcus epidermidis
Aspergillus plate=5 mins
ASP times—1800 s, 900 s, 300 s, 120 s, 60 s, 30 s
Aspergillus brasiliensis NCPF 2275

Probiotic testing is described separately further herein as modified testing protocols are needed.

The following examples are described: Examples 1 through 8 using standard bacteria E. coli (Table 1A); Examples 9 through 14 using multiple plates (Table 1B); and Examples 15 through 22 using standard bacteria E. coli (Table 1C).

### Determination of the Germ Reduction Based on Further Compositions of the Disinfectant Provided According to the Invention

Based on several aqueous liquid compositions for the disinfectant provided according to the invention, the germ reduction was again checked in detail. The compositions and results are combined in particular in the following Tables 1A-1C.

The Levenol F200 used is a non-ionic surfactant commercially available in the form of an aqueous solution on the following basis: C12-Lauric acid, glycereth 6 cocoate or polyethelene glycol ester. The Genapol 650 used is a non-ionic surfactant commercially available in the form of an aqueous solution on the following basis: C16-cetyl alcohol, Ceteareth-20 or ethoxylated alcohols. The Plantacare® 810 UP used is a non-ionic surfactant commercially available in the form of an aqueous solution on the following basis: C8-C10-alkyl polyglucoside or alkyl polyglycoside. The Plantacare® 1200 used is a non-ionic surfactant commercially available in the form of an aqueous solution on the following basis: C12-alkyl Laurl glucoside or alkyl polyglucocide The Kolliphor PS20 used is a non-ionic surfactant commercially available in the form of an aqueous solution on the following basis: C12-Lauric acid, polysorbates, polyethelene sorbitan esters (Tweens). Tween 80 used is a non-ionic surfactant commercially available in the form of an aqueous solution on the following basis: C18 Oleic acid, polysorbates, polyethylene sorbitan esters (tweens). Dermosoft® Octiol is a caprylyl glycol and represents a moisture regulating agent but also a selectively active/inactive effectant. Hydrolite 6 is a 1,2 hexanediol and represents a moisture-regulating agent but also a selectively active/inactive effectant. KOH is potassium hydroxide, also known as lye, and represents a pH-regulating agent. Fumaric acid is a plant based organic acid and represents plant-based acids that are not known to have any significant biological effect, as a pH-regulating agent. Balance of water reflects that some surfactants are normally shipped in water and the active % may vary due to manufacturing process or if pH is adjusted to ensure preservation.

TABLE 1A
Composition Examples 1 through 8 provided according to the invention
and their germ reduction for EN1276 using E. coli

| | Example | Example | Example | Example | Example | Example | Example | Example |
|---|---|---|---|---|---|---|---|---|
| | 1 | 2 | 3 | 4 | 5 | 6 | 7 | 8 |
| | % by | % by | % by | % by | % by | % by | % by | % by |
| Component | wt. | wt. | wt. | wt. | wt. | wt. | wt. | wt. |
| Demineralized | Balance | Balance | Balance | balance | Balance | Balance | Balance | Balance |
| water | of water | of water | of water | of water | of water | of water | of water | of water |
| Citric acid | 0.80 | 1.00 | 1.00 | 1.30 | 1.30 | 1.60 | 1.90 | 1.90 |
| mono | | | | | | | | |
| KOH as a pH | 1.8 | 2.00 | 3.00 | 2.00 | 3.00 | 2.00 | 3.00 | 3.00 |
| adjuster | | | | | | | | |
| Sodium | 0.01 | 0.50 | 0.50 | 0.40 | 0.40 | 0.35 | 0.25 | 1.0 |
| benzoate | | | | | | | | |
| Fumaric acid | 0.5 | 4.00 | 4.00 | 0.2 | 2.00 | 0.5 | 0.00 | 0.00 |
| as pH adjuster | | | | | | | | |
| Hydrolite 6 | 1.00 | 1.00 | 1.00 | 0.50 | 1.00 | 1.00 | 3.00 | 3.00 |
| Dermosoft ® | 0.2 | 0.50 | 0.50 | 0.50 | 1.00 | 2.0 | 0.4 | 0.4 |
| Octiol | | | | | | | | |
| Inulin as a | 0.3 | 0.5 | 1.0 | 0.0 | 4.0 | 1.0 | 1.5 | 1.5 |
| prebiotic | | | | | | | | |
| Genapol 650 | 0.8 | | 1.1 | | | 2.5 | | |
| Levenol F200 | 0.3 | | | | | | 4.8 | 4.8 |
| Plantacare | | | | | 2.0 | | | |
| 1200 | | | | | | | | |
| Plantacare 800 | | 0.8 | | 2.0 | 2.0 | | 3.0 | 3.0 |
| UP | | | | | | | | |
| Kolliphor | | | | | | 2.5 | 3.0 | 3.0 |
| PS20 | | | | | | | | |
| Tween 80 | 2.5 | | | | | | | |
| pH Value | 3.5 | 3.5 | 3.5 | 3 | 3 | 4.0 | 4.8 | 4.8 |
| Fastest Time | 300 s | 60 s | 60 s | 60 S | 60 s | 60 s | 60 s | 60 s |
| over all Plates | | | | | | | | |
| Log reduction | | | | | | | | |
| if not greater | | | | | | | | |
| than 5 | | | | | | | | |

TABLE 1B
Composition Examples 9 through 15 provided according to the
invention and their germ reduction for ASTMS multi-plates

| | Example | Example | Example | Example | Example | Example | Example |
|---|---|---|---|---|---|---|---|
| | 9 | 10 | 11 | 12 | 13 | 14 | 15 |
| Component | % by wt. | % by wt. | % by wt. | % by wt. | % by wt. | % by wt. | % by wt. |
| Demineralized | Balance of | Balance of | Balance of | Balance of | Balance of | Balance of | Balance of |
| water | water | water | water | water | water | water | water |
| Citric acid | 0.80 | 1.00 | 1.00 | 1.30 | 1.30 | 1.60 | 1.90 |
| mono | | | | | | | |
| KOH as a pH | 1.8 | 2.00 | 3.00 | 2.00 | 3.00 | 2.00 | 3.00 |
| adjuster | | | | | | | |
| Sodium | 0.50 | 0.50 | 0.50 | 0.40 | 0.40 | 0.35 | 0.25 |
| benzoate | | | | | | | |
| Fumaric acid as | 0.5 | 4.00 | 4.00 | 0.2 | 2.00 | 4.00 | 4.00 |
| pH adjuster | | | | | | | |
| Hydrolite 6 | 1.00 | 1.00 | 1.00 | 0.50 | 1.00 | 1.00 | 3.00 |
| Dermosoft ® | 0.2 | 0.50 | 0.50 | 0.50 | 1.00 | 2.0 | 0.4 |
| Octiol | | | | | | | |
| Inulin as a | 0.3 | 0.5 | 1.0 | 0.0 | 4.0 | 1.0 | 1.5 |
| prebiotic | | | | | | | |
| Genapol 650 | 0.8 | | 1.1 | | | 2.5 | |
| Levenol F200 | 0.3 | | | | | | 4.8 |
| Plantacare 1200 | | | | | 2.0 | | |
| Plantacare 800 | | 0.8 | | 2.0 | 2.0 | | 3.0 |
| UP | | | | | | | |
| Kolliphor PS20 | | | | | | 2.5 | 3.0 |
| Tween 80 | 2.5 | | | | | | |
| pH Value | 3.5 | 3.5 | 3.5 | 3 | 3 | 4.0 | 4.8 |
| Fastest Time | 300 s | 60 s | 60 s | 60 S | 60 s | 9 s | 9 s |
| over all Plates | | | | | | | |
| Log reduction if | | | | | | | |
| not greater than 4. | | | | | | | |

TABLE 1C
Composition Examples 16 through 22 provided according to the invention and
their germ reduction for ASTMS multi-plates with lowest plate identified

| | Example | Example | Example | Example | Example | Example | Example |
|---|---|---|---|---|---|---|---|
| | 16 | 17 | 18 | 19 | 20 | 21 | 22 |
| Component | % by wt. | % by wt. | % by wt. | % by wt. | % by wt. | % by wt. | % by wt. |
| Demineralized | Balance of | Balance of | Balance of | Balance of | Balance of | Balance of | Balance of |
| water | water | water | water | water | water | water | water |
| Citric acid | 0.80 | 1.00 | 1.00 | 1.30 | 1.30 | 1.60 | 1.90 |
| mono | | | | | | | |
| KOH as a pH | 1.8 | 2.00 | 3.00 | 2.00 | 3.00 | 2.00 | 3.00 |
| adjuster | | | | | | | |
| Sodium | 0.50 | 0.50 | 0.50 | 0.40 | 0.40 | 0.35 | 0.25 |
| benzoate | | | | | | | |
| Fumaric acid as | 0.5 | 4.00 | 4.00 | | 2.00 | 4.00 | 4.00 |
| pH adjuster | | | | | | | |
| | | | | 0.2 | | | |
| Hydrolite 6 | 1.00 | 1.00 | 1.00 | 0.50 | 1.00 | 1.00 | 3.00 |
| Dermosoft ® | 0.2 | 0.50 | 0.50 | 0.50 | 1.00 | 2.0 | 0.4 |
| Octiol | | | | | | | |
| Inulin as a | 0.3 | 0.5 | 1.0 | 0.0 | 4.0 | 1.0 | 1.5 |
| prebiotic | | | | | | | |
| Genapol 650 | 0.8 | | 1.1 | | | 2.5 | |
| Levenol F200 | 0.3 | | | | | | 4.8 |
| Plantacare 1200 | | | | | 2.0 | | |
| Plantacare 800 | | 0.8 | | 2.0 | 2.0 | | 3.0 |
| UP | | | | | | | |
| Kolliphor PS20 | | | | | | 2.5 | 3.0 |
| Tween 80 | 2.5 | | | | | | |
| pH Value | 3.5 | 3.5 | 3.5 | 3 | 3 | 4.0 | 4.8 |
| Slowest Time | | 60 s | 60 s | | | 60 s | 60 s |
| over all Plates | | | | | | | |
| Log reduction if | 0.8log | | | 0.4log | 21og | | |
| not greater than 4. | | | | | | | |

Thus, germ reductions of at least 4-log levels, particularly at least 5-log levels, are obtained, or even a germ reduction to a germ load that is below the detection limit is usually achieved within 30 s. This could be proven in common laboratory tests EN 1275, EN 1276/EN1650/EN 13727 and EN 14476 as well as in the use test according to EN 1500/EN 1499; and the newer laboratory tests EN17387, EN16777.

Furthermore, it was found in tests that microorganisms that are particularly difficult to kill, such as Candida albicans, which belong to the yeasts, can be reduced by at least 4 log levels, particularly at least 5-log levels, especially at least 6-log levels, and even at least 7-log levels within 30 s. This could be proven in common laboratory tests according to EN 1650/EN13624.

It is important to note that the two criteria of germ reduction by at least 4 log levels within 1 minute already fulfil the requirements for authorisation as a biocide in the European Union, depending on usage, e.g., food and feed on steel plates, but is not the primary objective of all exemplary compositions provided according to the invention.

Although no strong oxidising agents are used, the rehabilitation composition provides superior biocidal, especially bactericidal, fungicidal (e.g. levuricidal) and virucidal activity. In particular, a broad spectrum of antibacterial activity with high efficacy against gram-positive and gram-negative bacteria is observed. In addition to the bactericidal and virucidal effect, the rehabilitation composition is also used against fungi and yeasts. An insecticidal effect is also assumed.

According to one aspect of the present invention, a synergistic effect of the rehabilitation composition is assumed, in which the combination effect exceeds the effect of the individual components. This is surprising in that benzoates as preservatives and non-ionic surfactants have a slow activity at pH values <5 from a microbiological point of view and regularly only develop their efficacy after hours or even days, which is not a reasonable time period for a biocidal composition, since it is particularly desirable that a biocidal, in particular disinfecting, effect must take place in a very short time.

The rehabilitation composition provided according to the present invention contains one or more prebiotics and/or one or more probiotics and/or one or more postbiotics which have a positive effect on the treated surface after biocidal treatment or disinfection and support and promote the natural microbiome present and can contribute to restoring a natural microbiome. This refers to any kind of application of the rehabilitation composition, for example for surfaces of all kinds, such as objects as a whole or parts of objects, in particular surface disinfection, skin disinfection, especially hand disinfection, food disinfection, water disinfection, waste disinfection, plant disinfection, plant product disinfection, such as wood disinfection, laundry disinfection and room disinfection. The rehabilitation composition has a health-promoting effect on living beings, in particular humans, animals and/or plants.

In a completely unexpected way, the rehabilitation composition shows a selective effect. Harmful organisms are attacked, fought and destroyed immediately. For example, harmful bacteria are killed or reduced to a minimum within 60 seconds and harmful yeasts, such as Candida albicans, are destroyed or reduced to a minimum in 60 seconds. In contrast, positively acting bacteria, such as probiotics, are only minimally attacked, if at all, and are usually hardly affected and remain intact after biocidal treatment. Experiments show that the prebiotics, probiotics and/or postbiotics contained in the rehabilitation composition are stable during the biocidal treatment, even though the rehabilitation composition is designed to attack and destroy Predominately non-GRAS microorganisms.

It is also important that the probiotics remain in the rehabilitation composition for several days; in experiments their stability was tested up to 28 days. However, this also means that positive-acting microorganisms are also retained on the treated surface to a high degree, so that the existing natural microbiome is not destroyed, which the biocidal compositions known from the prior art regularly do. In other words, desirable microorganisms that are already on the surface are not eliminated by the application of the rehabilitation composition, or desirable microorganisms that are not yet on the surface are colonised there. In contrast, undesirable microorganisms are selectively attacked and killed.

In experiments, it has been found that the rehabilitation composition serves to maintain or restore the natural bacterial balance or natural microbiome on the biocide-treated surface, whether the surface is on a living being or an inanimate object. In other words, the ratio of harmful or pathogenic bacteria to beneficial or health-promoting bacteria is shifted towards the beneficial or health-promoting bacteria, i.e. the “good” bacteria are supplied and their growth promoted and the “bad” bacteria are reduced.

Despite the presence of prebiotics, probiotics and/or postbiotics in the rehabilitation composition, the effect of the rehabilitation composition is not adversely affected. In particular, the time for germ reduction is not affected in any way. The rehabilitation composition therefore acts in the desired manner even in the presence of probiotics/prebiotics/postbiotics.

The rehabilitation composition may be an aqueous liquid composition or a solid composition, in particular a concentrate. The solid should be understood as broadly as possible and includes, for example, a powder, granules and the like, but also solid-liquid mixtures with a high proportion of solid, for example more than 60% by weight, more than 65% by weight, more than 70% by weight or more than 75% by weight, i.e. solid-liquid mixtures which are not flowable, such as a paste.

The rehabilitation composition in the form of a solid composition as a concentrate is diluted with water for the respective application to obtain an aqueous liquid composition. Exemplary dilutions range from about 3.68% to about 50%. Other dilutions are also possible. According to the invention, the active substances: acid(s), benzoate(s), non-ionic surfactant(s), moisture regulating agent(s), prebiotic(s)/probiotic(s)/postbiotic(s) and optionally excipients are present in the rehabilitation composition in appropriate ranges of amounts as specified. In general, the dilution of the concentrate may be chosen such that the aqueous liquid rehabilitation composition with the described quantity ranges results. The efficacy of the aqueous liquid rehabilitation composition is thus particularly high. It is understood that the concentration of the rehabilitation composition can be adapted to the application.

The aqueous liquid rehabilitation composition generally has an acidic pH in the range of 1.5-4.2, particularly in the range of 2.0-4.1, especially in the range of 3.0 to 4.0.

The rehabilitation composition comprises one or more of a probiotic, a prebiotic and a postbiotic. For example, the rehabilitation composition may comprise one or more probiotics. According to an embodiment, topical probiotics are used, i.e. those that exhibit beneficial effects for application to the skin of humans or animals. The probiotics used are in particular selected from the group consisting of: strains of Alcaligenes, strains of Bacillus, strains of Bifidobacterium, strains of Clostridia, strains of Corynebacterium, strains of Enterococcus, strains of Escherichia, strains of Lactobacillus, strains of Lactococcus, strains of Pedicoccus, strains of Propionibacterium, strains of Saccharomyces, strains of Neurospora, strains of Aspergillus, and mixtures thereof. The probiotic can be any derivative of any type of probiotic.

For example, the one or more probiotics are selected from the following bacterial families: Acetobacteraceae, Acidaminacoccaceae, Actinomycetaceae, Acorcoccaceae, Bacillaceae, Bacteroidaceae, Bradyrhizobiaceae, Brucellaceae, Carnobacteriaceae, Caulobactereaceae, Chloroflexi, Chloroplasts, Clostridiaceae, Comamonadaceae, Corynebacteriaceae, Cyanobacteria, Enterobaceriaceae, Exiguobacteraceae, Flavobacteriaceae, Fusobacteriaceae, Gemellaceae, Intrasporangiaceae, Lachnospiraceae, Lactobacilloae, Micrococcaceae, Moraxellaceae, Neisseriaceae, Nocardiaceae, Pasteurellaceae, Peptostreptococcaceae, Planococcaceae, Porphyromonadaceae, Propionibacteriacea, Pseudomonodaceae, Rhodobacteriaceae, Sphingobacteriaceae, Sphingomonadaceae, Staphlococcaceae, Streptophyta, Veillonellaceae, and Xanthomonadaceae.

According to an embodiment, the following are used in particular as probiotics: strains of Bacillus, particularly Bacillus licheniformis, Bacillus subtilis, Bacillus coagulans, strains of Enterococcus, strains of Escherichia, strains of Lactobacillus, strains of Lactococcus, strains of Saccharomyces, strains of Neurospora, strains of Aspergillus and mixtures thereof. Commercially available products may be used.

The rehabilitation composition may comprise one or more prebiotics in addition to or instead of the probiotics. According to an embodiment, topical prebiotics are used, i.e. those that are beneficial for application to the skin of humans or animals. The prebiotics used are in particular selected from the group comprising or consisting of disaccharides, oligo- or polysaccharides, such as saccharose, lactose, maltose, trehalose, cellobiose, lactulose, parts or extracts of aralia plants, such as ginseng and taiga root (Eleutherococcus senticosus), beta-glucans, in particular cellulose, chitin, hemicelluloses, hexosans, pentosans, arabinoxylan, arabinogalactans, lignin, xanthan, lichenin, fructans, inulin, polyuronides, pectin, alginic acid and alginates, agar, carrageenan, raffinose, polydextrose, glucan oligosaccharides, in particular alpha- and beta-glucan oligosaccharides, galactooligosaccharides, in particular trans-galactooligosaccharides, xylooligosaccharides, frutooligosaccharides (oligofructose), glucomannans, locust bean gum, guar, starch, especially high amylose starch, resistant starch, starch degradation products such as dextrins, cyclodextrins, nerolidol-(3,7,11-trimethyl-1,6,10-dodecatrien-3-ol) extract, and xylitol.

According to an embodiment, the one or more prebiotics are selected from saccharose, lactose, maltose, trehalose, cellobiose, lactulose, inulin, fructans, fructooligosaccharides (oligofructose), galactooligosaccharides, pectin or resistant starch. These are available, for example, from extracts of chicory, artichokes, onions, parsnips, chicory root, salsify, sugar beet, garlic, bark or bark mulch, maize, yacon, Jerusalem artichoke, oats, barley, wheat, rye, pulses, asparagus, artichokes, soybeans, potatoes, rice, pasta or fruit. Commercially available products can be used.

The rehabilitation composition may comprise one or more postbiotics in addition to or instead of the probiotic(s) and/or prebiotic(s). The postbiotics used are, in particular, selected from the group consisting of bacterial lysates or bacterial ferments. Some examples are a ferment of Bacillus, particularly a ferment of Bacillus coagulans, Lactobacillus ferment, Lactobacillus lysate, Bifidobacterium lysate and mixtures thereof. An example is the commercially available Bacillus ferment Bonicel™, which is obtained by a fermentation process of a Bacillus coagulans in the supernatant.

The aqueous liquid rehabilitation composition comprises in particular 0.005 to 5.0% by weight prebiotic(s) and/or postbiotic(s), especially 0.006 to 5.0% by weight, 0.007 to 5.0% by weight, 0.008 to 5.0% by weight, 0.009 to 5.0% by weight, 0.01 to 5.0% by weight, 0.03 to 5.0% by weight 0.05 to 5.0% by weight 0.07 to 5.0% by weight 0.09 to 5.0% by weight 0.1 to 5.0% by weight 0.15 to 5.0% by weight, 0.2 to 5.0% by weight, 0.3 to 5.0% by weight, 0.4 to 5.0% by weight, 0.5 to 5.0% by weight, 0.5 to 4.5% by weight, 0.5 to 4.0% by weight, 0.5 to 3.5% by weight, 0.5 to 3.0% by weight, 0.5 to 2.5% by weight, 0.5 to 2.0% by weight, 0.5 to 1.8% by weight, 0.5 to 1.5% by weight, 0.5 to 1.5% by weight, or 0.5 to 1.0% by weight, depending on the application and based on the total weight of the rehabilitation composition.

The solid rehabilitation composition comprises in particular 0.03 to 25% by weight prebiotic(s) and/or postbiotic(s), 0.05 to 25% by weight, 0.07 to 25% by weight, 0.1 to 25% by weight, especially 0.2 to 25% by weight, 0.3 to 25% by weight, 0.4 to 25% by weight, 0.5 to 25% by weight, 0.6 to 25% by weight, 0.7 to 25% by weight, 0.8 to 25% by weight, 0.9 to 25% by weight, 1.0 to 20% by weight, 1.5 to 20% by weight, 1.6 to 20% by weight, 1.7 to 20% by weight, 1.8 to 20% by weight, 1.9 to 20% by weight, 2.0 to 18% by weight, 2.5 to 18% by weight, 3.0 to 18% by weight, 3.5 to 17% by weight, 3.5 to 15% by weight, 3.6 to 15% by weight, 3.7 to 15% by weight, 3.8 to 15% by weight, 3.9 to 15% by weight, 4.0 to 14% by weight, 4.5 to 13.5% by weight, 5.0 to 13% by weight or 5.5 to 12% by weight, 5.5 to 11.0% by weight or 5.5 to 10% by weight, depending on the application and based on the total weight of the rehabilitation composition.

The aqueous liquid rehabilitation composition contains probiotic(s) in particular in the range of from 103 to 109.9 CFU/g, especially 103.5 to 109.9 CFU/g or 104.0 to 109.9 CFU/g 104.5 to 109.8 CFU/g, 105 to 109.6 CFU/g, 105.5 to 109.5 CFU/g or 106 to 109 CFU/g.

The solid rehabilitation composition comprises the probiotic(s) in particular in such an amount so that the probiotic(s) in the aqueous liquid rehabilitation composition are obtained in a range of from 103 to 109.9 CFU/g probiotic(s), especially 103.5 to 109.9 CFU/g or 104.0 to 109.9 CFU/g 104.5 to 109.8 CFU/g, 105 to 109.6 CFU/g, 105.5 to 109.5 CFU/g or 106 to 109 CFU/g.

The rehabilitation composition further comprises one or more inorganic or organic acids, in particular one or more organic acids selected from hydrochloric acid, sulphuric acid, phosphoric acid, malic acid, anic acid, ascorbic acid, formic acid, benzoic acid, succinic acid, acetic acid, fumaric acid, methylglycinediacetic acid, ethylenediaminetetraacetic acid, fulvic acid, gentisic acid, glutamic acid, glycolic acid, butyric acid, isovaleric acid, caffeic acid (3,4 dihydroxycinnamic acid), maleic acid, malonic acid, mandelic acid, lactic acid, glutamic acid, oxalic acid, propionic acid, salicylic acid, tartaric acid, including the racemate of tartaric acid (racemic acid), cinnamic acid, citric acid, as well as peracids such as peracetic acid, peroctanoic acid, persorbic acid, perbenzoic acid, perpropionic acid, performic acid, perlactic acid, percitric acid, permalic acid and the like. The majority of organic acids are plant acids which occur in plants.

According to an embodiment, the rehabilitation composition comprises benzoic acid, ascorbic acid, fumaric acid, glycolic acid, lactic acid, methylglycinediacetic acid, ethylenediaminetetraacetic acid, fulvic acid, glutamic acid, propionic acid, salicylic acid, tartaric acid, citric acid, glycein, methionine, cysteine, and/or sulfuric acid in the form of ferrous sulphate.

Furthermore, experiments have surprisingly shown that the use of salicylic acid in the rehabilitation composition is particularly advantageous. In the pH range of 3.0 to 4.7, particularly in the pH range of 3.5 to 4.2, according to the invention, salicylic acid shows a highly disinfectant effect in combination with the other components, although benzoate may be omitted. Salicylic acid is not actually ascribed any disinfectant effect in this pH range.

A mixture of two or more acids, in particular a mixture of organic acids, can therefore also be used. The acids can also be in the form of alkali and/or alkaline earth salts. However, it may be preferred if only one acid is present in the rehabilitation composition. The acid(s) may also be plant or microorganism primary, secondary, or complex metabolites, including but not limited to hyaluronic acid, salicylic acid, fumaric acid, lactic acid, and/or citric acid, as previously described.

According to an embodiment, the one or more acids or alkali and/or alkaline earth salts thereof are present in the aqueous liquid rehabilitation composition in an amount selected from 0.1 to 3% by weight, 0.15 to 3% by weight or 0.2 to 3% by weight or 0.25 to 3% by weight or 0.3 to 2% by weight or 0.35 to 3% by weight, depending on the application and based on the total weight of the rehabilitation composition.

According to an embodiment, the one or more acids or their alkali and/or alkaline earth salts are present, depending on the application, in the solid rehabilitation composition, which is present in particular as a solid concentrate, in an amount selected from 0.5-15% by weight, 1.0-14% by weight, 1.0-13% by weight, 1.0-12% by weight, 1.0-10% by weight, in particular 1.5-8% by weight, based on the total weight of the rehabilitation composition.

As a further component, one or more benzoates are present in the rehabilitation composition provided according to the invention. These are selected, for example, from alkali benzoates or alkaline earth benzoates, in particular sodium benzoate, potassium benzoate, calcium benzoate, or a mixture thereof. Benzoic acid and its salts are mainly used as preservatives in small amounts. Due to their preservative properties, they are used, for example, in the food industry and in cosmetics. The effect as a preservative is much slower than required for a biocide, so that benzoates have not yet been used as biocidal or disinfectant agents. In the rehabilitation composition, the benzoates, if present, can develop a biocidal or disinfecting effect, in particular when they are completely dissolved. According to an embodiment, water-soluble alkali and/or alkaline earth benzoates are therefore optionally used, in particular for their enhanced preservative functions. In some embodiments, benzoate earth salts may be limited to 0.5% by weight in order to be labeled as GRAS in the United States of America and/or the European Union.

According to an embodiment, the one or more benzoates are present in the aqueous liquid rehabilitation composition in an amount selected from 0.1 to 1.0% by weight or 0.15 to 1.0% by weight, in particular 0.2 to 1.0% by weight, based on the total weight of the rehabilitation composition.

According to an embodiment, the one or more benzoates, depending on the application, are present in the solid rehabilitation composition, in particular as a solid concentrate, in an amount selected from 0.5 to 5% by weight, 1.0 to 4% by weight, 1.5 to 4.5% by weight, 1.5 to 4% by weight, 1.5 to 4% by weight, depending on the application and based on the total weight of the rehabilitation composition.

A further component of the rehabilitation composition provided according to the invention are one or more non-ionic surfactants which are soluble or emulsifiable or dispersible in water. According to the invention, no other surfactants are present in the rehabilitation composition, in particular no amphoteric surfactants, no anionic surfactants and no cationic surfactants. Non-ionic surfactants are generally advantageous as they are usually well tolerated by humans and animals and are non-irritating.

Non-ionic surfactants are surface-active substances that have no dissociable functional groups and therefore do not form ions in aqueous solution. These have a polar and a nonpolar molecular part, but no charge and are therefore neutral. The solubility of a non-ionic surfactant in water can be determined by the HLB value (hydrophilic-lipophilic balance). The HLB value indicates the mass ratio between the polar and the non-polar part in a non-ionic surfactant using the following formula:

HLB=20*(M_{hydrophil}/Mₜₒₜₐₗ)
where M_{hydrophil} is the molar mass of the hydrophilic portion of the non-ionic surfactant and Mₜₒₜₐₗ is the molar mass of the entire molecule. The factor 20 is a scaling factor. A HLB value of 1 corresponds to a lipophilic compound, a chemical compound with a HLB value of 20 has a high hydrophilic fraction. The HLB value of the non-ionic surfactant used according to the invention is ≥7 and includes not only clear solutions but also (stable) emulsions. The HLB value of the non-ionic surfactant used according to the invention can also be ≥12 or ≥13. The non-ionic surfactants which are soluble or emulsifiable or dispersible in water have in particular a high HLB value and therefore have the advantage that these provide good wetting of hydrophilic surfaces. This can be expected to improve the biocidal effect.

As an alternative to the HLB value, the turbidity point of the non-ionic surfactant can also be used. Above a certain temperature, non-ionic surfactants are no longer soluble in water and then form a surfactant-rich phase, which is indicated by a turbidity of the solution. This temperature is also called the “turbidity point” and can therefore be used to characterise water-soluble non-ionic surfactants. This turbidity point is higher if the HLB value is higher. The non-ionic surfactants used according to the invention therefore have a turbidity point of 40° C. or more in water.

The non-ionic surfactants are for example selected from fatty alcohol alkoxylates, such as polyalkylene glycol ethers (fatty alcohol ethoxylates), nonylphenol ethoxylates, fatty alcohol propoxylates, fatty amine alkoxylates, such as fatty amine ethoxylates, fatty acid ethoxylates, fatty acid polyglycol esters, fatty acid polyglycol amides, polyglycerol esters, polyoxyethylene glycol alkylphenol esters, octylphenol ethoxylates (octoxinol-9 or Triton X-100), alkanolamides, glycerol alkyl esters or sugar surfactants, such as alkyl glucosides, alkyl polyglucosides or alkyl polyglycosides, C8-C10 alkyl polyglucoside or C8-C10 alkyl polyglycoside, methyl glucoside esters, ethyl glucoside esters, N-methyl glucamide, sucrose esters, in each case alone or mixtures thereof.

According to an embodiment, non-ionic surfactants are selected from fatty alcohol alkoxylates and sugar surfactants, such as alkyl polyglucosides or alkyl polyglycosides (APGs), each alone or mixtures thereof. Fatty alcohol alkoxylates are polyalkylene glycol ethers, also known as fatty alcohol polyglycol ethers or fatty alcohol ethoxylates. They are non-ionic surfactants whose lipophilic part consists of fatty alcohols, in particular alcohols derived from lauric acid, palmitic acid, stearic acid or oleic acid, and whose hydrophilic part is composed of short-chain polyethylene glycols or polyoxyethylenes. Exemplary known trade names of polyalkylene glycol ethers are: Brij®, Genapol® 650 and Lutensol®. Polyalkylene glycol ethers as non-ionic surfactants are widely used in personal care products.

According to an embodiment, non-ionic surfactants are selected from polyalkylene glycol ethers, in particular polyoxyethylene ethers of lauryl alcohol, such as laureth-4 (fatty alcohol ethoxylates with 4EO=ethylene oxide units), laureth-6 (fatty alcohol ethoxylates with 6EO), laureth-9 (fatty alcohol ethoxylates with 9EO) or laureth-23 (fatty alcohol ethoxylates with 23EO); polyoxyethylene ethers of cetyl alcohol, such as ceteth-10 or ceteth-20; polyoxyethylene ether of cetylstearyl alcohol, such as ceteareth-20, ceteareth-25; polyoxyethylene ether of stearyl alcohol, such as steareth-10 or steareth-20; or polyoxyethylene ether of oleyl alcohol, such as oleth-10 or oleth-20), or C9-11 Pareth 8 (a fatty alcohol ethoxylate with 8 EO (ethylene oxide units), such as Genapol® UD 88).

According to an embodiment, the non-ionic surfactants are selected from alkyl polyglucosides or alkyl polyglycosides, in particular C₈-C₁₀ (octyl to decyl) polyglucosides or C₈-C₁₂ (octyl to duodecane) polyglycosides as well as cocopolyglucosides or cocopolyglycosides with a carbon-chain up to C₁₆/C₁₈.

Non-ionic surfactants, selected from sugar surfactants, consist of a polar water-soluble molecular part and a non-polar fat-soluble molecular part. They can be ethers, esters, amines or amides depending on the chemical bond between the sugar and the alkyl group. The HLB value of a sugar surfactant depends on the degree of polymerisation of the sugar as the polar group and the number and length of the alkyl chains. According to an embodiment, the non-ionic surfactants are selected from sugar surfactants, in particular alkyl glucosides, such as polysorbate 20 (Tween 20), alkyl polyglucosides or alkyl polyglycosides (APGs), which always have a HLB value of >10, such as, for example, Plantacare® (e.g. Plantacare® 810 UP: based on the following: C₈-C₁₀ alkyl polyglucosides or C₈-C₁₂ alkyl polyglycosides) or sorbitan esters, such as sorbitan monolaurate, which has a HLB value of 8.6. Sugar surfactants are environmentally compatible and usually show good skin compatibility and are used in the cosmetics industry, for example as ingredients of shampoos, hair conditioners, bath additives or skin cleansers.

According to an embodiment, the non-ionic surfactants are selected from sugar surfactants, in particular alkyl glucosides, such as polysorbate, alkyl polyglucosides or alkyl polyglycosides (APGs), for example caprylyl/capryl glucosides or glycosides, such as Plantacare®, or sorbitan esters, in particular sorbitan monolaurate, in each case alone or mixtures thereof. However, it may be advantageous if no polysorbate, in particular no polysorbate 80, is used as a non-ionic surfactant.

According to an embodiment, non-ionic surfactants are therefore in particular selected from polyalkylene glycol ethers selected from the group consisting of polyoxyethylene ethers of lauryl alcohols, such as laureth-4, laureth-6, laureth-9 or laureth-23, polyoxyethylene ethers of cetyl alcohols, such as ceteth-10 or ceteth-20, polyoxyethylene ethers of cetylstearyl alcohols, such as Ceteareth-20, Ceteareth-25, polyoxyethylene ethers of stearyl alcohols, such as Steareth-10 or Steareth-20, or polyoxyethylene ethers of oleyl alcohols, such as Oleth-10 or Oleth-20, alkyl polyglucosides or alkyl polyglycosides (APGs), in particular C8-C10 alkyl polyglucosides or C8-C10 alkyl polyglycosides, for example C8-C10 alkyl polyglucosides or C8-C12 alkyl polyglycosides, for example caprylyl/capryl glucosides or glycosides, such as Plantacare® (e.g. Plantacare® 810 UP: based on the following: C8-C10-alkyl polyglucosides or C8-C12 alkyl polyglycosides) or C9-11 Pareth 8 (a polyalkylene glycol ether, in particular a fatty alcohol ethoxylate with 8EO; “Pareth-” designates a PEG ether of an alkanol (alkyl alcohol); the preceding numbers “Cx-y” indicate the length of the alkyl (carbon) chains; the number after “Pareth-” indicates the average number of molecular units —CH₂—CH₂—O—), such as Genapol® UD 88, or sorbitan esters, such as sorbitan monolaurate, in each case alone or mixtures of these.

According to an embodiment, the non-ionic surfactants are in particular selected from clearly water-soluble non-ionic surfactants, such as polyoxyethylene ethers of lauryl alcohols, C9-C11 pareth-8, alkyl polyglucosides or alkyl polyglycosides, in particular C₈-C₁₀-alkyl polyglucosides or C₈-C₁₂ alkyl polyglycosides or sorbitan esters.

According to an embodiment, only one or more alkyl polyglucosides or alkyl polyglycosides (APGs) are present as non-ionic surfactants in the rehabilitation composition and no other non-ionic surfactants are present.

According to an embodiment of the present invention, the one or more non-ionic surfactants, depending on the application, are present in the aqueous liquid rehabilitation composition in an amount selected from 1.0 to 5.0% by weight, 1.1 to 5.0% by weight, 1.1 to 4.9% by weight, 1.1 to 4.8% by weight, 1.1 to 4.5% by weight, 1.1 to 3.9% by weight, 1.1 to 3.8% by weight, 1.1 to 3.5% by weight, 1.1 to 3.0% by weight, 1.1 to 2.9% by weight, 1.1 to 2.8% by weight, 1.1 to 2.7% by weight, 1.1 to 2.6% by weight, 1.1 to 2.5% by weight, 1.1 to 2.4% by weight 1.1 to 2.3% by weight, 1.1 to 2.2% by weight 1.1 to 2.1% by weight or 1.1 to 2.0% by weight, depending on the application and based on the total weight of the rehabilitation composition.

According to an embodiment, the one or more non-ionic surfactants are present in the solid rehabilitation composition, in particular in the form of a solid concentrate, in an amount selected from 2.0-25% by weight, 2.5-20% by weight, 3.0-18% by weight, 4-16% by weight or 5-15% by weight, depending on the application and based on the total weight of the rehabilitation composition.

By way of explanation, “glucosides” are actually organic compounds in which an alcohol is bound to glucose via a glycosidic bond. “Glycosides” are organic compounds in which an alcohol is bound to a sugar via a glycosidic bond. Glucosides therefore represent a subgroup of glycosides. However, the terms are not used consistently in the prior art, as glucosides are often also used to refer to glycosides. In the present invention, the terms are therefore intended to be used interchangeably so that a glucoside also includes the glycoside and vice versa.

A further component of the rehabilitation composition is one or more moisture regulating agents, also referred to here as ‘moisturisers’ or ‘moisturising agent,’ that also have a purpose as solvents. These are, for example, glycols with 2 to 10 carbons, such as butylene glycol, propylene glycol (1,2-propanediol), 1,2-pentanediol, hexylene glycol (2-methyl-2,4-pentanediol), 1,2-octanediol (trade name Dermosoft® Octiol), capric glycol, 1,2-hexanediol (trade name Hydrolite 6), xylitol as well as glycine or glycerine.

It was found that moisture regulating agents additionally significantly support the biocidal or disinfecting effect. In particular, when fungicidal germs such as Candida albicans and Aspergillus brasiliensis are present, it has been found that the efficacy of the rehabilitation composition according to the invention can be significantly improved by the presence of one or more moisture regulating agents.

According to an embodiment, the one or more selectively active/inactive effectants/moisture regulating agents are present in the aqueous liquid rehabilitation composition, in particular in an amount ranging from 0.1 to 6% by weight. In particular, the moisture control agents are present in an amount in the range of 0.1 to 6.0% by weight, 0.2 to 6.0% by weight, 0.3 to 6.0% by weight, 0.4 to 6.0% by weight, 0.5 to 6.0% by weight, 0.6 to 6.0% by weight, 0.7 to 6.0% by weight, 0.8 to 6.0% by weight, 0.9 to 6.0% by weight, 1.0 to 6.0% by weight or 1.5 to 6.0% by weight or 1.8 to 6.0% by weight or 2.0 to 6.0% by weight or 2.5 to 6.0% by weight, dependent on the application and based on the total weight of the rehabilitation composition. According to an embodiment, the one or more moisture regulating agents are particularly present in an amount in the range of 1.0 to 6.0% by weight, such as up to 3.0% by weight.

According to an embodiment, the one or more moisture regulating agents are present in the solid rehabilitation composition, which is a solid concentrate, in an amount selected from 1.0-25% by weight, 1.5-20% by weight, 2.0-18% by weight, 5.0-16% by weight or 7.5-15% by weight, depending on the application and based on the total weight of the rehabilitation composition.

According to an embodiment, if two or more moisture regulating agents are present in the liquid rehabilitation composition at the same time the amount of one moisture regulating agent used may be present in the liquid rehabilitation composition in the range of 1.5 to 4.0% by weight and the other moisture regulating agent(s) present make-up the remaining amount of moisture regulating agent(s)

Water is used as the solvent for the rehabilitation composition. If the disinfectant is used in the cosmetic field, for example for facial or hand disinfection, purified, germ-free water is used for the production of the cosmetic product. This can be distilled water or water demineralised by ion exchange or reverse osmosis and thus germ-free. Drinking water or, for certain applications, tap water can also be used.

According to an embodiment, the rehabilitation composition contains in particular at least 75% by weight or at least 80% by weight or at least 85% by weight or 90% by weight or at least 91% by weight or at least 92% by weight, at least 93% by weight, at least 94% by weight, at least 95% by weight, at least 96% by weight, at least 97% by weight or at least 98% by weight of water, in particular up to 98.695% by weight of water may be present. Some embodiments may contain up to 65% or up to 70% by weight of water.

The rehabilitation composition may contain one or more excipients. According to an embodiment, in addition to acid(s), non-ionic surfactant(s), moisturiser(s), (optionally) benzoate(s), and prebiotic(s)/probiotic(s)/postbiotic(s), only excipients are present. The excipients comprise or consist, for example, of fragrances, such as perfumes, colourants, (natural) plant extracts, solubilising agents, thickening agents, preservatives and monovalent salts, in particular alkali salts of the monovalent salts. Fragrances used are, for example, essential oils such as lavender oil, peppermint oil or a ginger macerate. Ginger macerates are water extracts, especially cold water extracts, of ginger to dissolve its ingredients. Instead of a ginger macerate, the ingredients of ginger in the form of gingerols and shogaols, 6-gingerol, could also be added in a suitable amount. Solubilising agents are used, for example, to solubilise the essential oil(s), such as polyglyceryl-10-laurate.

According to another embodiment it may be advantageous to replace water by 2-phenoxyethanol, in particular up to 20% by weight, up to 15% by weight, up to 10% by weight, up to 7.5% by weight, up to 5% by weight, up to 4% by weight, up to 3% by weight, up to 2% by weight or up to 1% by weight of 2-phenoxyethanol may be present in the aqueous liquid rehabilitation composition. It was found that 2-phenoxyethanol can increase the disinfecting effect in some embodiments. 2-Phenoxyethanol is also known as a moisture regulating agent, but is understood as a solvent or selectively active/inactive effectant in the present invention. In the present invention, the moisture regulating agents are considered separately without 2-phenoxyethanol. According to another embodiment it may be advantageous to exclude 2-phenoxyethanol (0% by weight 2-phenoxyethanol) from the rehabilitation composition due to disadvantageous effects in some applications.

The exemplary excipients in the rehabilitation composition can be selected by the skilled person against the background of the combination of the other ingredients with a view to complete compatibility with them and added in appropriate, sufficient amounts, if desired. It is understood that all the ingredients of the rehabilitation composition add up to 100% by weight.

Excipients are generally categorised as inert/inactive ingredients used in product formulations. This may be confirmed as part of normal testing. A universal standard of Pour plate neutralisation is used, and a test sample is taken to consider it alongside the sample with the excipient in it, in any given instance this is carried out in all formulations specific to a given aspect of the invention; the ingredient(s) is then defined as an active ingredient (effectant) or a selectively active/inactive excipient. This is of great importance when probiotics are present and has to be again tested over the life as they may secrete metabolites; for example, yeast may secrete ethanol (as they do in wine) and also where a selective effect is identified like one that only effects aerobic bacteria so the formula would work differently for fungus.

Excipients can fulfil a variety of functions, for example:
Excipients, in contrast to the active substance, usually have no active substance activity. Because of this, the functions of excipients and active substances are different.
Excipients serve a specific purpose to support the desired function of a product formulation and may even help to reduce the amount of the active substance.
Properties of the product formulations (e.g. stability) can be influenced by the excipients chosen, their concentrations and their interactions with the active ingredient and with each other. However, excipients alone do not achieve this performance.

The rehabilitation composition provided according to the present invention can be provided in various forms, for example as a water-containing solution or dispersion, in particular a slurry, lotion, spray, gel, foam or also as a solid water-dispersible concentrate, in particular selected from powder, granules or paste. The solvent used is water. According to an embodiment, alcohol solvents, such as methanol, ethanol, propanol, pentanol, hexanol, or their isomers or mixtures, are not used. However, according to an embodiment an additional solvent that may be present in the liquid rehabilitation composition is, for example, ethanol, which may be added in an amount of up to 3.0% by weight, up to 2.5% by weight, up to 2.0% by weight, up to 1.5% by weight or up to 1.0% by weight; for example 0.1 to 1.5% by weight, or 0.1 to 1.0% by weight or 0.1 to 0.5% by weight, based on the total weight of the liquid rehabilitation composition. In experiments it was found that it is advantageous if a small amount of ethanol of up to 3.0% by weight is present in the rehabilitation composition, which can increase the disinfecting effect in some embodiments. According to another embodiment it may be advantageous to exclude ethanol (0% by weight ethanol) from the rehabilitation composition due to disadvantageous effects in some applications.

According to an embodiment the compounds chlorhexidine digluconate and sorbitan caprylate (0.0% by weight) are not present.

A variety of carriers may be used to dispense the rehabilitation composition, such as pads, bandages, plasters, sticks, aerosol dispensers, pump sprays, wipes and the like impregnated with the rehabilitation composition. For example, the rehabilitation composition can be used in any type of dispenser, such as a pump dispenser that is free-standing or wall-mounted, and can be activated manually or automatically. The rehabilitation composition may be dispensed from a dispenser, for example, as a gel or a foam. Delivery as a foam may be advantageous as this may well be assumed to have a longer evaporation time, resulting in a longer contact time, avoiding spray mist, likely reducing the required dose and resulting in visible evidence of the treated area.

The biocide composition provided according to the invention, in particular the disinfectant provided according to the invention, is only intended for external use according to an embodiment. In particular, there is no application to the mouth and the oral region, the nose, the eyes, the vaginal region or the anal region. Furthermore, therapeutic use of the biocide composition provided according to the invention in humans and animals is generally excluded.

Subject of the present invention is also the use of the rehabilitation composition in skin disinfection, particularly facial or hand disinfection, food, equipment and surface disinfection, in particular in cosmetics, in the food sector, in the medical and veterinary sector, in agriculture and pasture farming, in animal husbandry and breeding, in plant cultivation and care, wherein in particular an exposure time of the disinfectant of 30 s is sufficient to show its complete biocidal effect. The use of the rehabilitation composition is particularly advantageous where undesirable bacteria are to be destroyed and desirable bacteria are to be settled or promoted.

It may be particularly advantageous that components known to be safe are used in the rehabilitation composition. To evaluate the efficacy and safety of chemical disinfectants and antiseptics, there are standards, such as the EN 14885 standard, which manufacturers, users and responsible regulatory authorities, such as the ECHA (European Chemicals Agency) or EMA (European Medicines Agency), refer to. Here, not only the fast and comprehensive germ reduction, sufficient penetration depth, effective resistance, but also a low systemic toxicity and good skin compatibility play a role. The designation GRAS-Generally Recognized As Safe or GRASE—Generally Recognized As Safe And Effective of the FDA (U.S. Food and Drug Administration) as well as other standards of the U.S. Environmental Protection Agency and the U.S. Food and Drug Administration, which contribute to assessing rehabilitation compositions in terms of their effect and safety, are also well-known.

Thus, the rehabilitation compositions provided according to the present invention can be generally regarded as safe and effective, the individual components all being GRAS components in the above sense: GRAS acid(s) which can be used in the food sector, benzoate(s) as GRAS preservatives which can also be used in food, GRAS moisturiser(s) which can be used in the cosmetics sector, non-ionic surfactant(s) which can be used in the cosmetics sector and is/are to be regarded as GRAS, and also, inter alia, prebiotic(s) and/or probiotic(s) which are known for cosmetic use and which are also to be regarded as GRAS. As a rule, water is used as a solvent, which is also GRAS. Consequently, the rehabilitation composition as a whole is also to be regarded as GRAS. Nevertheless, the rehabilitation composition can be considered equivalent in its effect compared to known strong biocides.

The rehabilitation composition provided according to the invention can exert its biocidal effect equally on hard and porous, soft surfaces, and can be used in particular for humans, animals, plants and objects. This can maintain or even improve the naturally occurring skin or surface microbiome.

Currently, it is common practice to treat or disinfect the skin and surfaces with biocides and, if necessary, to reapply the desired positive-acting microorganisms in a second step. On the one hand, it would therefore be advantageous if the positive-acting bacteria were not attacked at all during the biocidal treatment, but were preserved. In addition, it is time consuming and cost-intensive if a two-step procedure has to be carried out in which all bacteria are first destroyed indiscriminately in the first step and the positive-acting bacteria have to be reintroduced in the second step.

According to the invention, the cumbersome two-step procedure is now combined in one step saving time and reducing the risk of non-compliance by removing interdependency, whereby at the same time the rehabilitation composition not only selectively kills the undesired pathogens, but the positively acting bacteria can remain in place and even desired bacteria are added as needed, and their multiplication is specifically promoted. This succeeds in enhancing the natural microbiome with selected bacteria that colonise the surface and then grow with a desired population mix.

The process described above is further complicated if the surface needs to be cleaned with conventional disinfectants prior to the application of a disinfectant. In this case, the rehabilitation composition is an effective but gentle cleanser that makes it possible to reduce the overall three-step process to a one-step process, reducing the total treatment time by about 66%. That is, the cleaning, drying, disinfection, drying, rinsing and probiotic application is reduced to the application of the rehabilitation composition provided according to the present invention.

An advantageous example application of the rehabilitation composition is the biocidal treatment of stables or enclosures used in animal husbandry and breeding (pigs, cattle, horses, in zoos). At present, it is common practice to carry out a cumbersome and time-consuming two-step procedure in which first disinfection is carried out and then the positive-acting bacteria are sprayed back onto the walls, for example. In contrast, with the rehabilitation composition according to the invention, this can be done simultaneously in one step. Thus, disinfection and positively acting bacteria are supplied at the same time. The selective effect of the rehabilitation composition means that not all bacteria are destroyed by the rehabilitation composition: Essentially, only the harmful bacteria are attacked, the positive bacteria are only affected to a small extent. This has a positive effect on the microbiome. In addition, the desired bacteria can be added to the surface in a targeted manner, whereby the cleaning and inoculation with bacteria takes place in one step.

The use of rehabilitation compositions containing probiotics according to the invention in traditional processes also leads to a significantly improved effectiveness in these processes: It is assumed that a kind of displacement effect or “crowding out” is brought about, whereby microorganisms already present are displaced by the newly introduced microorganisms in the form of the probiotics, so that this competition between the various microorganisms results in an improved effect of the rehabilitation composition.

If probiotics and prebiotics are added at the same time in the rehabilitation composition according to the invention, the probiotics are supported and promoted even more in their growth and multiplication. This has an additional positive effect on the area to be cleaned/treated.

The rehabilitation composition probably also has an insecticidal effect, which is beneficial for plant care and cultivation. This could be advantageous for applications under the bark layer of trees, thus disrupting the life cycle of insects by killing them at the larval stage, which would be beneficial in an agricultural or specifically arable environment, e.g. fruit trees. The rehabilitation composition would also be of particular advantage in nature reserves and national parks, in the case of large-scale insect infestation, such as the European spruce bark beetle, where the prevention of colonies would be the main focus.

According to an embodiment, the rehabilitation composition may also be used for plants, for example applied to plant leaves or roots, thereby also supporting the regenerative microbiome in the soil, which may reduce the need for fertiliser. The rehabilitation composition can also be used beneficially on food crops, such as wheat, by promoting plant growth and thriving, flowering and fruiting, and supporting desirable bacterial colonisation of the plants. When harvested, these crops can be expected to be beneficial in the human and animal food chain, with fewer pesticides and insecticides and a higher yield.

The rehabilitation composition can also be used in further processing methods and the formation of natural fertilisers and animal feed: For example, in the production of mulch from plant residues, such as bark chaff, grasses, leaves and the like, or in the production of silage from straw, maize, grass, clover and the like, increasing the growth of desirable bacteria and reducing the growth of harmful bacteria, while at the same time supporting the fermentation process. This has a positive effect on the quality of the natural fertiliser and feed obtained. This can, for example, increase the energy and nutrient content for the animals, support their immune system, increase milk production and possibly even reduce the use of medicines to keep the animals healthy.

The rehabilitation compositions can be used, for example, in cosmetics in “rinse off” or “leave on” formulations of all kinds. The rehabilitation composition may also be applied to the skin, for example face or hands, to maintain the natural pH of the skin. The rehabilitation composition provided according to the present invention can be used multiple times daily. The rehabilitation compositions may also find use for personal, animal and plant hygiene.

The rehabilitation composition can be used, for example, in the food sector, in the production, processing, transport and sale of food. In particular, in the processing of meat for biocidal treatment of surfaces, tools and the like in the slaughterhouse, in the transport of foodstuffs for biocidal cleaning of the transport containers, for example before or after transport, or in the sale, for example for biocidal cleaning of displays, showcases, refrigerators and the like.

Another possible use is in in situ production sterilisation processes. This is the application in manufacturing processes in which raw materials are used that need to be sterilised for processing or further processing and it is important to maintain, regenerate and promote the natural microbiome. For example, the rehabilitation composition is therefore also used in cosmetic production, where particular importance is attached to low-germ raw materials. This also applies to in situ production sterilisation processes in which problematic, germinated raw materials have to be sterilised. These can be, for example, graters or abrasives in the form of natural untreated germ flours, such as olive kernel flour, apricot kernel flour, walnut shell flour, corn flour and the like. The raw materials can be sterilised directly in the manufacturing process without having to use a complex irradiation process (gamma radiation) or a heating process (at >70° C.). Upstream complex sterilisation processes of raw materials can therefore be omitted.

The rehabilitation composition can also be used for disinfection of particulate matter of any kind.

Indoors, the rehabilitation composition can be used as a disinfectant that reduces pathogens and promotes the growth of beneficial bacteria to further improve the standard of living and wellbeing of humans and animals. This can have a positive impact on patient care and nursing, especially in hospitals and their surroundings.

The rehabilitation composition can be readily used in conjunction with the HACCP colour coding system to identify specific areas. This improves infection control, for example in hospitals.

According to an embodiment, a liquid aqueous rehabilitation composition is provided comprising or consisting of:
0.01 to 3% by weight of acid(s) or alkali and/or alkaline earth salts thereof;
1.0-5.0% by weight non-ionic surfactant(s);
0.1 to 20% by weight of one or more solvents;
0.005 to 5.0% by weight prebiotic(s) and/or postibiotic(s),
and/or probiotic(s) in particular in the range of from 103 to 109.9 CFU/g;
and optionally excipients, such as
0 to 2.0% by weight of one or more perfumes;
0 to 5.0% by weight of one or more monovalent salts selected, for example, from NaCl, KCl and/or LiCl;
0 to 2.0% by weight plant extracts;
0 to 5.0% by weight of solubilising agents; and
the remaining balance by weight is water.

It is particularly advantageous that the rehabilitation compositions provided according to the present invention requires no requirements for personal protection equipment, or specialised recycling or handling as it can be generally regarded as safe and effective, the individual components all being GRAS or GRASE components (GRAS—Generally Recognized As Safe or GRASE—Generally Recognized As Safe And Effective of the FDA). Other strong biocides generally do not allow safe and suitable control of the bacterial infestation.

In addition, the rehabilitation composition provided according to the present invention contains one or more prebiotics and/or one or more probiotics and/or one or more postbiotics by which the disinfectant effect of the rehabilitation composition is not adversely affected. In particular, the time for germ reduction is not affected in any way. The rehabilitation composition therefore acts in the desired manner even in the presence of probiotics/prebiotics/postbiotics.

Furthermore, the presence of probiotics/prebiotics/postbiotics has a very positive effect on the treated surface after biocidal treatment or disinfection and support and promote the natural microbiome present and can contribute to restoring a natural microbiome. In fact, the rehabilitation composition has a health-promoting effect on living beings, in particular humans, animals and/or plants. Some examples of post biotics produced by subtillus bacillus are: Bacteriocins: These are antimicrobial peptides that are secreted by subtillus bacillus and other probiotic bacteria to inhibit the growth of pathogenic bacteria. Bacteriocins can improve the intestinal microbiota homeostasis and protect against infections for 24 hours. Hormone-like substances are molecules that are synthesized or modified by subtillus bacillus and can affect the growth, flowering, and maturation of plants, as well as the nutritional and physiological mechanisms of animals.

In a completely unexpected way, the rehabilitation composition shows a selective effect on organisms, particularly microorganisms, whereby harmful organisms such as harmful bacteria and harmful yeasts are killed within 30 seconds. In contrast, positively acting bacteria such as probiotics, are only minimally attacked, if at all, and are usually hardly affected and remain intact after biocidal treatment. In other words, desirable microorganisms that are already on the surface are not eliminated by the application of the rehabilitation composition, or desirable microorganisms that are not yet on the surface are colonised there. In contrast, undesirable microorganisms are selectively attacked and killed.

Further, it has been found that the rehabilitation composition serves to maintain or restore the natural bacterial balance or natural microbiome on the biocide-treated surface, whether the surface is on a living being or an inanimate object. That is, the ratio of harmful or pathogenic bacteria to beneficial or health-promoting bacteria is shifted towards the beneficial or health-promoting bacteria, i.e. the “good” bacteria are supplied and their growth promoted and the “bad” bacteria are reduced.

The rehabilitation composition provided according to the present invention can be provided in various forms, and can be customized to the intended use and is extremely versatile. The rehabilitation composition provided according to the invention can exert its biocidal effect equally on hard and soft surfaces, and can be used in particular for humans, animals, plants and objects.

The common practice of treating or disinfecting the skin and surfaces with biocides in a first step and reapplying desired beneficial microorganisms in a second step can be accomplished in a single step by the rehabilitation composition provided according to the present invention. According to the invention, prior cleaning of the surfaces to be disinfected is not necessary, as is the case with conventional disinfectants, since the rehabilitation composition is an effective but gentle cleanser. This means time savings of up to about 66% compared to conventional methods.

Thus, a disinfectant effect and positively acting microorganisms are supplied at the same time. The selective effect of the rehabilitation composition means that only the harmful bacteria are attacked, the positive bacteria are only affected to a small extent. This has a positive effect on the microbiome. In addition, the desired bacteria can be added to the surface in a targeted manner, whereby the cleaning and inoculation with bacteria takes place in one step. This makes it possible to improve the natural microbiome with selected bacteria that colonize the surface and then grow in a desired population mix.

The use of rehabilitation compositions containing probiotics according to the invention may be used in traditional processes and also leads to a significantly improved effectiveness in these processes: It is assumed that a kind of displacement effect or “crowding out” which is in a part is brought about by accelerated growth from targeted prebiotics and postbiotics and, whereby microorganisms already present are displaced by the newly introduced microorganisms in the form of the probiotics, so that this competition between the various microorganisms results in an improved effect of the rehabilitation composition.

If probiotics and prebiotics are added at the same time in the rehabilitation composition according to the invention, the probiotics are supported and promoted even more in their growth and multiplication. This has an additional positive effect on the area to be cleaned/treated.

The use of rehabilitation compositions is not limited and can be used, for example, for surfaces of all kinds, such as objects as a whole or parts of objects, in particular surface disinfection, skin disinfection, especially hand disinfection, food disinfection, water disinfection, waste disinfection, plant disinfection, plant product disinfection, such as wood disinfection, laundry disinfection and room disinfection. It may be used in cosmetics, in the food sector, in in situ production sterilisation processes, for disinfection of particulate matter of any kind, in indoor applications, especially in hospitals and their surroundings, the rehabilitation composition may also be used for plant care and cultivation, in further processing methods and the formation of natural fertilisers and animal feed, in animal husbandry and breeding, e.g. for pigs, cattle, horses, and in zoos and many other applications more.

The use of the rehabilitation composition is particularly advantageous where undesirable bacteria are to be destroyed and desirable bacteria are to be settled or promoted.

Accordingly, the rehabilitation composition provided according to the present invention is characterised by a high biocidal, in particular disinfectant effect, activity and has high bactericidal, fungicidal (levuricidal) and virucidal and probably also insecticidal activity. The rehabilitation composition represents a very fast-acting rehabilitation agent that selectively destroys essentially only harmful bacteria and contributes to the promotion of a natural microbiome.

Although embodiments provided according to the invention have been described herein, it is understood that many modifications may be made without departing from the invention and scope of the general inventive concept. All such modifications are intended to be included within the scope of the invention, which is limited only by the appended claims.

In the following, the present invention will be explained in more detail by examples, without limiting the invention.

### Exemplary Products

Exemplary product for a general rehabilitation composition—It is envisaged that it will be dispensed as a foam, liquid gel or used as a pre-soaked wipe that can be synthetic or of natural fibre origin. The first step involved producing the inactive micellar water comprising or consisting of one or more non-ionic surfactant one or more solvents and a pH buffer required for the application which consist of one or more acids and their alkali and or alkaline earth salts. Once the vessel has been charged with water, the surfactants and solvents are added sequentially, stirred for 10 minutes within 2 minutes or until such time as the solution is clear, thereafter the acids and pH buffers are added. The clear solution is then adjusted to a pH that is preferred to be between pH 3.0 and pH 4.0 (to support the hand acid barrier) The resulting liquid concentrate with the formula: Plantacare 810 UP between 0.15% and 1.1%; Hydrolite 6 between 0.1% and 4%; Citric acid between 0.11 and 1.1% and sodium citrate between 0% and 2% (furthermore all acids with a pKa between 2 and 5 can be used); Inulin between 0.3% and 1% is added as a general prebiotic. The resulting solution when diluted to the RTU (ready to use) concentration was found to (buffer) at pH 3.5, to not require any personal protective equipment, or special disposal or recycling, and shows no corrosive activity on the desired materials within the target range and when tested against an exemplary microorganism resulted in no detectable reduction in the microorganism.

In a second step, the selectively active/inactive effectants are selected to comprise or consist of one or more additional solvents, one or more acids or their alkali, and or alkaline earth salts, are added to the micellar water first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; Phenoxyethanol between 0.05% and 0.8% increasing phenoxythenol above 1.2% resulted in stability issues; Sodium benzoate between 0.03% and 0.5%. The resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilus). In step four, other inactive ingredients such as colour, perfumes, thickeners can be added to create a RTU product suitable for commercial use.

The resulting solution when diluted to the RTU formula and was found to sustain the probiotic (exemplary Bacillus subtilus) at a significant number of CFU, reducing in the first hour and then plateauing for the next 28 days; the RTU solution can then be used to reduce the exemplary microorganism (Candida albicans) by greater than 4 steps without a reduction in the inoculated organism on the surface or in solution. The fifth and final step is to confirm dermatological compatibility for the skin. dosage and application, wipe, spray, gel or foam and discern the correct ml for use so as to create a suitable set of instructions for application and use. Furthermore, the microorganisms of concern and those that are probiotics shall be verified by an independent lab as to the effective log reduction or lack thereof. With this solution a 5 ml solution per square meter was enough to cleanse evenly with a reusable microfiber wipe, started to dry in patches after 3 minutes at 20 degrees Celsius and was completely dry by 5 minutes. The 3 minutes represents a time resulting in a negligible reduction on the probiotics on the surface and in the composition, and to have the desired reduction in the exemplary organism more than 4 log steps. The low dosage also resulted in a short drying time, and so reduced the carbon footprint of the process.

Exemplary product for a cosmetic composition—It is envisaged that the cosmetic is a water based cleanser, micellar water for use on all non-mucous membrane surfaces of the skin, be mild to special skin types such as baby's, diabetes and persons with sensitive skin types. It will be dispensed as a foam, liquid gel, liquid and used as a rinse off and leave on product. The first step involved producing the inactive micellar water comprising or consisting of one or more non-ionic surfactants, one or more solvents and a pH buffer required for the application which consists of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier) The resulting liquid concentrate with the formula: Plantacare 810 UP between 0.15% and 1.1%; Hydrolite 6 between 0.1% and 4%; Citric acid between 0.11 and 1.1% and sodium citrate between 0% and 2% (furthermore all acids with a pKa between 2 and 5 can be used); Inulin between 0.3% and 1% is added as a general prebiotic The resulting solution when diluted to the RTU (ready to use) concentration was found to (buffer) at pH 3.5, to not require any personal protective equipment, or special disposal or recycling, and show no corrosive activity on the desired materials within the target range and when tested against an exemplary microorganism resulted in no detectable reduction in the microorganism. In a second step the selectively active/inactive effectants are selected to comprise or consist of one or more additional solvents, one or more acids or their alkali, and or alkaline earth salts, are added to the micellar water first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; 2-Phenoxyethanol between 0.05% and 0.8% increasing 2-phenoxythenol above 1.2% resulted in stability issues; Sodium benzoate between 0.03% and 0.5%. propylene glycol between 0.1 and 0.5%; Diethylene glycol monomethyl ether between 0.1 and 0.5%. The resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilus). In step four other inactive ingredients such as colour, perfumes, thickeners can be added to create a RTU product suitable for commercial use. The resulting solution when diluted to the RTU formula and was found to sustain the probiotic (exemplary Bacillus subtilus) at a significant number of CFU, reducing in the first hour and then plateauing for the next 28 days. The selection of probiotics is chosen to attain a skin rejuvenation, anti-aging, effect, skin tonifying, depollution and reduction minor skin irritations. The fifth and final step is to confirm dermatological compatibility for the skin. In general, the goal is to strengthen the naturally occurring skin microbiome of the person, possibly to augment the natural biome with microbiome enhancing pre- and pro-biotics. Dosage and application, creme, spray, gel, slurry or foam and discern the correct ml for use so as to create a suitable set of instructions for application. Furthermore, the microorganisms of concern and those that are probiotics shall be verified by an independent lab as to the effective lack of log reduction.

Exemplary product for a medicated composition—It is envisaged that the medicated composition is a water-based cleanser, micellar water for use on all surfaces of the skin including mucous membranes, be mild to special skin types such as baby's, diabetes and persons with sensitive skin types. It will be dispensed as a foam, liquid gel, crème, suppository, liquid and used as a rinse off and leave on product. The first step involved producing the inactive micellar water comprising or consisting of one or more non-ionic surfactants, one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier) The resulting liquid concentrate with the formula: Plantacare 810 UP between 0.15% and 1.1%; Hydrolite 6 between 0.1% and 4%; Citric acid between 0.11 and 1.1% and sodium citrate between 0% and 2% (furthermore all acids with a pKa between 2 and 5 can be used); Inulin between 0.3% and 1% is added as a general prebiotic. The resulting solution when diluted to the RTU (ready to use) concentration was found to (buffer) at pH 3.5, to not require any personal protective equipment, or special disposal or recycling, and show no corrosive activity on the desired materials within the target range and when tested against an exemplary microorganism resulted in no detectable reduction in the microorganism.

In a second step the selectively active/inactive effectants are selected to comprise or consist of one or more additional solvents, one or more acids or their alkali, and or alkaline earth salts, are added to the micellar water first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; 2-Phenoxyethanol between 0.05% and 0.8% increasing 2-phenoxythenol above 1.2% resulted in stability issues; Sodium benzoate between 0.03% and 0.5% propylene glycol between 0.1 and 0.5%; Diethylene glycol monomethyl ether between 0.1 and 0.5%. The resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilus). In step four, other inactive ingredients such as colour, perfumes, thickeners can be added to create a RTU product suitable for commercial use. The resulting solution when diluted to the RTU formula and was found to sustain the probiotic (exemplary Bacillus subtilus) at a significant number of CFU, reducing in the first hour and then plateauing for the next 28 days; the RTU solution can then be used to reduce the exemplary microorganism (Candida albicans) by greater than 4 steps without a reduction in the inoculated organism on the surface or in solution.

The fifth and final step is to confirm dermatological compatibility for the skin. In general, the goal is to strengthen the naturally occurring skin microbiome of the person, possibly to augment the natural biome with microbiome enhancing pre and pro biotics. Dosage and application, creme, spray, gel, suppository, slurry or foam and discern the correct ml for use so as to create a suitable set of instructions for application.

The resulting solution when in the RTU formula and was found to sustain the amino acid (exemplary 1-glutamine and inulin) at 0.1 and 1%, The RTU application can then be used to reduce the exemplary pathogenic microorganism such as Candida auris or Candida albicans exemplary for yeast, as well as other bacteria that may be populating the different parts of the human skin by greater than 4 steps. The envisaged applications are thus as a whole-body shower application, mouth wash, vaginal or anal suppository yet not limited to these applications.

Furthermore, the microorganisms of concern and those that are probiotics shall be verified by an independent lab as to the effective lack of log reduction.

Exemplary product for a virucidal composition—It is envisaged that the virucidal composition is a water-based cleanser, micellar water for use on all surfaces of the skin including mucous membranes, be mild to special skin types such as baby's, diabetes and persons with sensitive skin types. It will be dispensed as a foam, liquid gel, wipe, liquid and used as a rinse off product. The first step involved producing the inactive micellar water comprising or consisting of one or more non-ionic surfactants, one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier) The resulting liquid concentrate with the formula: Plantacare 810 UP between 0.1% and 1.4%; Hydrolite 6 between 0.1% and 4%; Dodecyldimethylamine oxide between 0.1% and 0.4%; Citric acid between 0.11% and 1.3% and sodium citrate between 0% and 2% (furthermore all acids with a pKa between 2 and 5 can be used); Inulin between 0.3% and 1% is added as a general prebiotic. The resulting solution when diluted to the RTU (ready to use) concentration was found to (buffer) at pH 3.5, to not require any personal protective equipment, or special disposal or recycling, and show no corrosive activity on the desired materials within the target range and when tested against an exemplary microorganism resulted in no detectable reduction in the microorganism.

In a second step, the selectively active/inactive effectants are selected to comprise or consist of one or more additional solvents such as propylene glycol and or Diethylene glycol monomethyl ether one or more acids or their alkali, and or alkaline earth salts, are added to the micellar water; first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; Phenoxyethanol between 0.05% and 0.8%; Sodium benzoate between 0.03% and 0.5%; propylene glycol between 0.1 and 0.5%; Diethylene glycol monomethyl ether between 0.1 and 0.5%. The resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than a reference viricide. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilus). In step four, other inactive ingredients such as colour, perfumes, thickeners can be added to create a RTU product suitable for commercial use. The resulting solution when diluted to the RTU formula and was found to sustain the probiotic (exemplary Bacillus subtilus) at a significant number of CFU, reducing in the first hour and then plateauing for the next 28 days; The fifth and final step is to confirm dermatological compatibility for the skin. In general, the goal is to have a virucidal effect on enveloped and non-enveloped viruses. Dosage and application, creme, spray, gel, slurry or foam and discern the correct ml for use so as to create a suitable set of instructions for application.

The resulting solution when in the RTU formula and was found to sustain the amino acid (exemplary Glycine between 0.00 and 0.5%, Cysteine between 0.00 and 0.5% and Inulin at 0.3%) at 0.1 to 2% in total. The RTU application (with the probiotic step removed to facilitate the testing process) can then be used to reduce the exemplary pathogenic microorganism enveloped viruses (vaccinia virus VR-1508 [Modified Vaccinia Ankara]) as well as non-enveloped viruses (Human Adenovirus 5 Adenoid 75) as well as other viruses that may be populating the different parts of the human skin by greater than equal reduction to that of a reference viricide (Glutardialdehyde).

Exemplary product for a general plant rehabilitation composition—in the form of a foliar barrier spray—It is envisaged that it will be dispensed as a foam for visibility or a liquid. The first step involved producing the inactive micellar water comprising or consisting of one or more non-ionic surfactants, one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier, which is relevant to when a human may handle the composition for spraying or other forms of application). The resulting liquid concentrate with the formula: Plantacare 810 UP between 0.15% and 1.1%; Hydrolite 6 between 0.1% and 4%; Citric acid between 0.11 and 1.1% and sodium citrate between 0% and 2% (furthermore all acids with a pKa between 2 and 5 can be used); Inulin, which as an osmolyte has a positive effect on plant leaves, as it helps them survive and thrive in different environmental conditions, between 0.3% and 1%. The resulting solution when diluted to the RTU (ready to use) concentration was found to (buffer) at pH 3.5, to not require any personal protective equipment, or special disposal or recycling or effect pets or livestock, and show no corrosive activity on horticultural or agricultural materials within the target range and when tested against an exemplary microorganism resulted in no detectable reduction in the microorganism.

In a second step, the selectively active/inactive effectants are selected to comprise or consist of one or more additional solvents, one or more acids or their alkali, and or alkaline earth salts, are added to the micellar water; first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; Sodium benzoate between 0.01% and 0.3%, salicylic acid between 0.01 and 0.3%, fumaric acid between 0.5 and 1% and the resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary 1-glutamine and Inulin). The resulting solution when diluted to the RTU formula and was found to sustain the amino acid (exemplary 1-glutamine and inulin) at 0.1 and 1%. The RTU solution can then be used to reduce the exemplary microorganism (Klebsiella pneumonia for bacteria and Candida albicans for yeasts) by greater than 4 steps without a reduction in the amino acid on the surface or in solution. The fourth and final step is to confirm compatibility for the plant foliage. dosage and application, wipe, spray, gel or foam and discern the correct ml for use so as to create a suitable set of instructions for application and use. Over a period of 6 months from spring to autumn, migratory insects were not affected but larvae of Aphididae failed to hatch, Diplocarpon rosae and Puccinia lycopersici failed to gain hold on leaves or transfer from one plant to another, and drought stress response increased, in a 2 control plant and a 2 treated Rosa x hybrida, and an open-pollinated non-hybrid tomato plant as well as an increase in buds, flowers and fruits. This was attributed to a statistically important increase in the plant's production of Auxins, in particular Indole acetic acid, melatonin, spermidine but no statistical increase in volatile organic compounds.

Exemplary product for a general plant rehabilitation composition—in the form of a leaf shine—It is envisaged that it will be dispensed as a foam for visibility or a liquid. The first step involved producing the inactive micellar water comprising or consisting of one or more non-ionic surfactants, one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier). The resulting liquid concentrate with the formula: Plantacare 810 UP between 0.15% and 1.1%; Hydrolite 6 between 0.1% and 4%; Citric acid between 0.11 and 1.1% and sodium citrate between 0% and 2% (furthermore all acids with a pKa between 2 and 5 can be used); Inulin, which as an osmolyte has a positive effect on plant leaves, as it helps them survive and thrive in different environmental conditions, between 0.3% and 1%. The resulting solution when diluted to the RTU (ready to use) concentration was found to (buffer) at pH 3.5, to not require any personal protective equipment, or special disposal or recycling or effect pets or livestock, and show no corrosive activity on horticultural or agricultural materials within the target range and when tested against an exemplary microorganism resulted in no detectable reduction in the microorganism.

In a second step, the selectively active/inactive effectants are selected to comprise or consist of one or more additional solvents, one or more acids or their alkali, and or alkaline earth salts, are added to the micellar water first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; salicylic acid between 0.01 and 0.3%, fumaric acid between 0.5 and 1%. The resulting solution, when diluted to the RTU concentration, was found to buffer at pH 3.5, to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilis).

The resulting solution when diluted to the RTU formula and was found to sustain the probiotic (exemplary Bacillus subtillis) at a significant number of CFU, reducing in the first hour and then plateauing for the next 28 days, The RTU solution can then be used to reduce the exemplary microorganism (Klebsiella pneumonia for bacteria and Candida albicans for yeasts) by greater than 4 steps without a reduction in the amino acid on the surface or in solution. The fourth and final step is to confirm compatibility for the plant foliage dosage and application, wipe, spray, gel or foam and discern the correct ml for use so as to create a suitable set of instructions for application and use. Initially contaminants were wiped easily from the leaves and over a period of 6 months leaves maintained their shine, chlorophyl increased, and drought resistance increased and visitation from migratory insects reduced, e.g., in houseplants, common fruit fly reduced to zero on treated plants for the period.

Exemplary product for a plant and rehabilitation composition—in the form of a root drench—It is envisaged that it will be dispensed as crystals for visibility or a liquid. The first step involved producing a crystalised mix of acids and pH buffers are added. The clear solution is then adjusted to a pH that may be between pH 3.0 and pH 4.0 (to support and promote the pH ramp guiding microorganisms and nutrients to the roots). The resulting concentrate with the formula: Citric acid between 1% and 2% and sodium citrate between 1% and 2%. In step 2, active/inactive effectants are selected to comprise or consist of one or more additional solvents, one or more acids or their alkali, and/or alkaline earth salts, are added. Sodium benzoate between 0.01% and 0.3%, salicylic acid between 0.01% and 0.3%, fulvic acid between 0.5% and 1% (furthermore all acids with a pKa between 2 and 5 can be used). The resulting crystalline or solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics in this case inulin between 0.05% and 0.25%, which are to be transported and inoculated into the soil with the formula the resulting (exemplary Bacillus subtilis, l-glutamine, inulin).

The RTU solution can then be used to reduce the exemplary microorganism (Klebsiella pneumonia for bacteria and Candida albicans for yeasts) by greater than 4 steps without a reduction in the amino acid in the soil or in solution and the selected probiotic replaces the Klebsiella for nitrogen fixing amongst other things. The fourth and final step is to confirm compatibility for the plant and soil conditions. Dosage and application was at 20 g per metric tonne of plant/tree mass being treated every 3 weeks or a similar amount diluted in water, wipe, spray, gel or foam and discern the correct ml for use so as to create a suitable set of instructions for application and use. Over a period of 6 months from spring to autumn, migratory beetles were not affected but larvae of bark beetle that are normally protected under the bark were killed by the modified tree sap of the trees normal defence system and so failed to hatch, so failed to gain hold on leaves or transfer from one plant/tree to another, and drought stress response increased. In 8 control plants/trees and a 2 treated Pinus sylvestris, pH was measured at the root ball and the microorganisms in the soil counted. The result initially was a soil pH of 4.2; in the case of the forest pine was temporarily lowered to pH 3.5 and the soil contained 375 ug C/g of microorganisms in the sample: 25% fungal organisms, 75% bacteria. Three weeks later, the pH had recovered to 5.2 in one case and 4.9 in another; all control trees were still at 4.2 bacteria. Microorganisms at the roots of the control was still at the same levels for the treated trees; the microorganisms at the roots had increased 568 ug C/g and 51% fungal and 49% bacteria. And the beetle infestation had stopped with no activity and the bore holes filled and blocked with sap. This will continue in the next growing season with a larger sample. And 2 open-pollinated non-hybrid tomato plants had similar effect; pH in the garden environment was over pH 7.0, dropped temporarily to pH 5.5 and settled at pH 6.5, two days later the initial microorganisms at the roots showed an exhausted soil at only 46 ug=0.0:1, 3 weeks later the pH had risen to 6.8 but importantly the soil microorganism count had risen to 375 ug C/g: fungi 43%, bacteria 57%.

Exemplary product for a livestock waste neutraliser and rehabilitation composition—in the form of a foam—It is envisaged that it will be dispensed as foam. The first step involved producing the inactive micellar water comprising or consisting of one or more non-ionic surfactant one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier). The resulting liquid concentrate with the formula: Plantacare 810 UP between 0.15% and 1.1%; Hydrolite 6 between 0.1% and 4%; lactic acid between 0.5 and 1.1% and sodium citrate between 0% and 2% and ferrous sulphate between 0% and 1.5% (furthermore all acids with a pKa between 2 and 5 can be used); Inulin between 0.3% and 1% is added as a known excellent prebiotic for lactus bacillus The resulting solution when diluted to the RTU (ready to use) concentration was found to (buffer) at pH 3.5, to not require any personal protective equipment, or special disposal or recycling, and show no corrosive activity on the desired materials within the target range and when tested against an exemplary microorganism resulted in no detectable reduction in the microorganism. The third step is to add nitrifying bacteria containing strains of Nitrosomonas promote the process of nitrification converting toxic ammonia to nitrite and Nitrobacter converting nitrite to nitrate at a level between 750000 and 750000000 Bacteria [CFU/mL]. The RTU solution can then be used to reduce the exemplary microorganism (Klebsiella pneumonia for bacteria and Candida albicans for yeasts and Methanosarcina sp. TS2 for archae) by greater than 4 steps without a reduction in the amino acid in the livestock waste or in solution but a reduction in the ability to produce methane and ammonia emissions, and the selected probiotic replaces the Klebsiella for nitrogen fixing amongst other things reducing the impact on both animal and human welfare.

The fourth and final step is to confirm treated animal waste is compatible for the improvement of plant and soil conditions. Dosage and application were at 201 per metric tonne of livestock waste mass being treated and ideally applied within 2 hours and 18 hours of exiting the animal. The waste is then stored for a period of 6 to 26 weeks a temperature dependant time period. At which point during storage emissions on ammonia and methane and ammonia emissions are reduced by between 10.0 and 85.0%. When analysed for soil improvement, the slurry is adjusted with an alkalising composition (crushed cement) to a pH of between 4 and 5.8 and at this point would support a further probiotic of I. sakaiensis (increasing its ability to break down microplastics in the soil releasing more sources of carbon and Terephthalic acid which results in a statistical increase in plant defence mechanisms as with others of the Pseudomonas family these would have been statistically reduced by the original pH) and diluted 10 to 1 in water, forming a combined nutrient and nitrate slurry and microbiological analysis can discern the correct application rate for use so as to create a stable source of nutrients over the growing period of 6 months from spring to autumn.

Exemplary product for a rehabilitation composition to be used on human skin—It is envisaged that it will be dispensed as a foam, liquid gel or used as a pre-soaked wipe that can be synthetic or of natural fibre origin and used for both skin and surfaces. The first step involved producing the inactive micellar water comprising or consisting of one or more non-ionic surfactant one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that is preferred to be between pH 3.0 and pH 4.0 (to support the hand acid barrier) but also is capable of buffering down the skin from a usual 4.5 pH temporarily. The resulting liquid concentrate with the formula: Plantacare 810 UP between 1.0% and 1.5%; Hydrolite 6 between 3% and 4%; Citric acid between 0.9 and 1.1% and sodium citrate between 0% and 2% (furthermore all acids with a pKa between 2 and 5 can be used); Inulin between 0.1% and 1% is added as a general prebiotic, and xylitol between 0.1 and 1% also as a humectant for the skin. The resulting solution when diluted to the RTU (ready to use) concentration was found to (buffer) at pH 3.5, to show a dermatologically excellent impact on the skin and against an exemplary microorganism E. coli resulted in no detectable reduction in the microorganism.

In a second step the selectively active/inactive effectants are selected to comprise or consist of one or more additional solvents, one or more acids or their alkali, and or alkaline earth salts, are added to the micellar water first the alkalis and or alkaline earth salts and then the acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7%; Diethylene glycol monomethyl ether between 2.4 and 4.8%, Phenoxyethanol between 0.05% and 0.8% (increasing phenoxythenol above 1.2% resulted in stability issues); Sodium benzoate between 0.03% and 0.5%. The resulting solution when diluted to the RTU concentration was found to buffer at pH 3.5 and when tested against an exemplary microorganism and virus resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (within a time of 2 minutes. No third step to add probiotic colour, perfumes, thickeners were added as one preferred commercial product is without these.

The final step is to confirm dermatological compatibility for the skin dosage and application, wipe, spray, gel or foam and discern the correct ml for use so as to create a suitable set of instructions for application and use. Furthermore, the microorganisms of concern shall be verified by an independent lab as to the effective log reduction or lack thereof. With this solution, a 1.7 ml solution for two hands when rubbed for 1 minute to perform equivalent to a Reference (60% Propan-2-ol)

Exemplary product for a virucidal rehabilitation composition—It is envisaged that the virucidal rehabilitation composition is a water-based cleanser, micellar water for use on all surfaces of the skin. It will be dispensed as a foam, liquid gel, wipe, liquid and used as a rinse off product. The first step involved producing the inactive micellar water comprising or consisting of one or more non-ionic surfactants, one or more solvents and a pH buffer required for the application which consist of one or more acids and their alkali and or alkaline earth salts. Once the vessel has been charged with water the surfactants and solvents are added sequentially, stirred for 10 minutes within 2 minutes or until such time as the solution is clear, thereafter the acids and pH buffers are added. The clear solution is then adjusted to a pH that may be between pH 3.0 and pH 4.0 (to support the hand acid barrier) The resulting liquid concentrate with the formula: Plantacare 810 UP between 0.1% and 1.1%; Hydrolite 6 between 0.1% and 4%; Citric acid between 0.11% and 1.1% and sodium citrate between 0% and 2% (furthermore all acids with a pKa between 2 and 5 can be used); Inulin between 0.3% and 1% is added as a general prebiotic. The resulting solution when diluted to the RTU (ready to use) concentration was found to (buffer) at pH 3.5, to not require any personal protective equipment, or special disposal or recycling, and show no corrosive activity on the desired materials within the target range and when tested against an exemplary microorganism resulted in no detectable reduction in the microorganism.

In a second step, the selectively active/inactive effectants are selected to comprise or consist of one or more additional solvents such has propylene glycol and or Diethylene glycol monomethyl ether one or more acids or their alkali, and or alkaline earth salts, are added to the micellar water first the alkalis and or alkaline earth salts and then the Acids to a level where there is no change in the pH resulting in a liquid concentrate, it is then further mixed for at least 5 minutes until such solution is homogeneous and checked that none of the components have precipitated out. The resulting liquid concentrate with the formula: Micellar water between 1% and 98.7% and sodium benzoate between 0.03% and 0.5%. The resulting solution when diluted to the RTU concentration was found to buffer at pH 3.5 to not require any personal protective equipment, or special disposal or recycling, and show no corrosive activity on the desired materials all within the target range and when tested against an exemplary microorganism resulted in a reduction in the microorganism to a level greater than 4. The third step is to add the required probiotic, or amino acid to the formula selecting from the group of bacilli and within the amino acids and/or a yeast, fungus, or bacteria from the list of probiotic organisms, and its preferred prebiotic from the list of prebiotics which are to be transported and inoculated onto the surface with the formula the resulting (exemplary Bacillus subtilus). In step three, other inactive ingredients such as colour, perfumes, thickeners can be added to create a RTU product suitable for commercial use. The resulting solution when diluted to the RTU formula and was found to sustain the probiotic (exemplary Bacillus subtilus) at a significant number of CFU, reducing in the first hour and then plateauing for the next 28 days.

The fourth and final step is to confirm dermatological compatibility for the skin. In general, the goal is to have a virucidal effect on enveloped and non-enveloped viruses. Dosage and application, creme, spray, gel, slurry or foam and discern the correct ml for use so as to create a suitable set of instructions for application.

The resulting solution when in the ready to use solution and was found to sustain the amino acid (exemplary 1-glutamine and methionine and cysteine and inulin) at 0.1 to 3%. The solution can then be used to reduce the exemplary pathogenic microorganism including enveloped viruses (vaccina and H1N1, coronavirus) as well as non-enveloped viruses such as Adeno and Noro viruses as well as other viruses that may be populating the surface more than 2 log steps. The envisaged applications are thus as a surface any of the previously envisaged uses, but not limited to these applications.

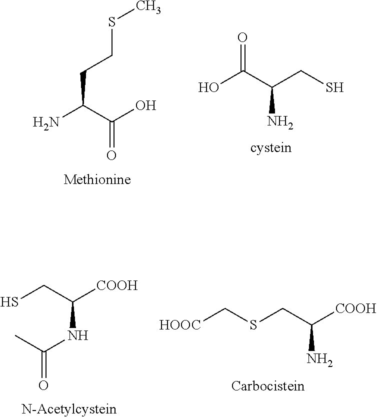

The above shown structures are representations of possible amino acids that due to their combination of thiol and amine in one molecule may assist in denaturing the envelope and the capsid in all virus types thus allowing the solution to enhance its virucidal function. In the case of chiral molecules, both D and L versions can be used alone or in combination; the proportion of each racemate is not important. It is also possible that there be a R substitution at the N position consisting of C1-C6 carbon chain that may be branched or linear. It is also possible to substitute the N of amino acids with different carboxylic acids, such as acetic acid, to achieve an amide. It is also possible that the thiol SH can be substituted with R in the length of C1-C6 as a linear of branched carbon chain. It is also possible to substitute the S of amino acids with different carboxylic acids, such as acetic acid, to achieve a S-carboxy bond.

The basis is that the above-mentioned amino acids are known in pharmacology to break the disulfide bridges in proteins, thus helping in dissolving phlegm in the respiratory tract. As similar action can be envisaged in the breaking of disulfide bonds in the envelopes and capsid of viruses.

Furthermore, the microorganisms of concern and those that are probiotics shall be verified by an independent lab as to the effective lack of log reduction.

### Exemplary Product for a General Rehabilitation Composition—Over an Extended Time-Period

According to an embodiment of the invention directed against Escherichia coli, the general rehabilitation composition was tested. Deviating from normal standard procedures, the following test procedure was chosen: Approximately 24 h before the test against Escherichia coli, about 109 CFU per mL of Bacillus subtilis spores in powder form were added to the reminder of the prepared rehabilitation composition. After about 24 h, 8 parts rehabilitation composition (+Bacillus subtilis) were mixed with 1 part loading solution (0.3 g/L bovine serum albumin) and 1 part inoculum (Escherichia coli; see the following Table 2 for concentration) (80% final concentration of rehabilitation composition+B. subtilis). At the selected time points, the above mixture was neutralized as follows: mix 1 mL of the test solution+1 mL water+8 mL neutralization solution (5% Tween 80+2% lecithin+0.6% Na oleate, the effectiveness has already been demonstrated in other experiments) and determine the bacterial content by means of dilutions. Remaining Escherichia coli cells were determined using CASO agar and Escherichia coli selective agar.

The inoculation concentration is shown in the Table 2 below:

TABLE 2

| bacterium | strain# |
|---|---|
| Escherichia coli | DSM 1576 \| ATCC 8739 |
| inoculation concentration [log10 CFU/g] | 8.0 |

The results of the quantitative initial germ content determination (M01.01.02) are shown in the following Table 3:

TABLE 3

| | | | | Total bacterial |
|---|---|---|---|---|
| Sample | Bacteria | Yeast | Fungi | count TBC |
| General | — | — | — | — |
| Rehabilitaion | | | | |
| composition | | | | |

“—” = <7 CFU/g or mL - multiplied by the potential dilution factor

Bacterial counts correspond to CFU/g or mL in relation to the original product

After 30 seconds of exposure to the biocide composition according to the invention (+Bacillus subtilis powder, added 24 hours before testing), the bacterial counts for Escherichia coli given in the following Table 4 were found:

TABLE 4

| Time point | Bacteria [CFU/ml] | Yeasts/Fungi |
|---|---|---|
| 30 sec | 5 | n.d. |

Figures are mean values of inoculations in CFU/g or mL | n.d.=not performed The absolute values indicated in Table 4 are given below in Table 5 as log reduction levels

TABLE 5

| Time point | Bacteria | Yeasts/Fungi |
|---|---|---|
| 30 sec | 7.3 | n.d. |

Figures are mean values of vaccinations in CFU/g or mL |
n.d. = not performed

The rehabilitation composition of Example 4 (shown in Table 1A) reduced Escherichia coli in the present test by >7.3 log levels right from the starting point.

Example 12 (Table 1B): Investigation of the exposure time with a rehabilitation composition provided according to the invention against Candida albicans.

The general rehabilitation composition was tested.

Deviating from the standard procedure of M04.01.01, the following test procedure was chosen:

Approximately 24 h before the test against Candida albicans, about 109 CFU per mL of Bacillus subtilis spores in powder form were added to the reminder of the prepared rehabilitation composition. After about 24 hours, 8 parts rehabilitation composition (+Bacillus subtilis) were mixed with 1 part loading solution (0.3 g/L bovine serum albumin) and 1 part inoculum (Candida albicans; for concentration, see the following Table 6) (80% final concentration of the rehabilitation composition+B. subtilis). At the selected time points, the above mixture was neutralized as follows: mix 1 mL of the test solution+1 mL water+8 mL neutralization solution (5% Tween 80+2% lecithin+0.6% Na oleate, the effectiveness has already been demonstrated in other experiments) and determine the bacterial content by means of dilutions. Remaining Candida albicans cells were determined using Sabouraud+chloramphenicol agar.

TABLE 6

| Yeast | Strain# |
|---|---|
| Candida albicans | DSM 1386 \| ATCC 10231 |
| inoculation concentration [log10 CFU/g] | 8.2 |

The results of the quantitative initial germ content determination (M01.01.02) are shown in the following Table 7:

TABLE 7

| | | | | Total bacterial |
|---|---|---|---|---|
| Sample | Bacteria | Yeast | Fungi | count TBC |
| General | — | — | — | — |
| Rehabilitaion | | | | |
| composition | | | | |

“—” = <7 CFU/g or mL - multiplied by the potential dilution factor

Bacterial counts correspond to CFU/g or mL in relation to the original product

The determined values for Candida albicans are summarised in Table 8 below:

TABLE 8

| Time point | Bacteria [CFU/ml] | Yeasts/Fungi [CFU/ml] |
|---|---|---|
| start | n.d. | 5.0. |
| 30 sec | n.d. | 5.0 |

Figures are mean values of inoculations in CFU/g or mL | n.d.=not performed

The absolute values indicated in Table 8 are given below in Table 9 as log reduction levels:

TABLE 9

| Time point | Bacteria | Yeasts/Fungi |
|---|---|---|
| start | n.d. | 7.5 |
| 30 sec | n.d. | 7.5 |

Figures are mean values of inoculations in CFU/g or mL | n.d.=not performed

The rehabilitation composition reduces Candida albicans in the present test by >7.5 log levels right from the starting point.

Example: Investigating the persistence of probiotics in the rehabilitation composition of the present invention

Exemplary rehabilitation composition with: Bacillus subtilis (BCL)

### a) Short-Term Test for 15 h

The aim of the test is to test the effect of the rehabilitation composition on the germ or on the spores of the specified germ. For this purpose, the germ is added directly to the rehabilitation composition as a spore powder. The change in germ content is determined after the specified time periods by inoculation with several dilutions (without neutralizing agent) (1st batch for 1.5 h-3 h-6 h-12 h values). As it is not possible to obtain a 15 h value within one working day, a separate batch (2nd batch for the 15 h value) was provided for this value, incubated overnight and measured after 15 h.

Method: M01.01.02, version: 02.01/20.10.2022; (Standard) method: Ph. Eur. 6.8-Germ content, Chapter: 2.6.12; Deviations/more detailed description: No neutralization/(dilution), single determination unless otherwise stated. Method: M04.01.01 Vers: 01.01/05.08.2021 (Standard) method: Ph. Eur. 7.0-KBT, Chapter: 5.1.3. deviations/more detailed description: shortened time intervals, additional germs, mixed inoculum, inoculations according to M01.01.02.

The rehabilitation composition of Example 12 was used. The probiotic added was Bacillus subtilis. The inoculation concentration was [log 10 CFU/g]: 10^{8.9}.

The determined germ content values for Bacillus subtilis in the 1st batch are summarised in the Table 10 below:

TABLE 10

| Time | Bacteria [CFU/mL] | Yeasts/Fungi [CFU/mL] |
|---|---|---|
| Start | 750000000 | n.d. |

| | | | |
|---|---|---|---|
| 1.5 | h | 180000000 | n.d. |
| 3 | h | 100000000 | n.d. |
| 6 | h | 26000000 | n.d. |
| 12 | h | 5800000 | n.d. |

The figures are mean values of the inoculations in CFU/g or mL
n.d. = not determined

The absolute values for Bacillus subtilis determined in Table 10 are given below in Table 11 as log reduction levels.

TABLE 11
expressing the values indicated in Table
10 as log reduction (1st batch)

| Time | Bacteria [CFU/mL] | Yeasts/Fungi [CFU/mL] |
|---|---|---|
| Start | 0.0 | n.d. |

| | | | |
|---|---|---|---|
| 1.5 | h | 0.6 | n.d. |
| 3 | h | 0.9 | n.d. |
| 6 | h | 1.5 | n.d. |
| 12 | h | 2.1 | n.d. |

n.d. = not determined

The determined germ content values for Bacillus subtilis in the 2nd batch are summarised in the Table 12 below:

TABLE 12

| Time | Bacteria [CFU/mL] | Yeasts/Fungi [CFU/mL] |
|---|---|---|
| Start | 870000000 | n.d. |
| 15 h | 2300000 | n.d. |

The figures are mean values of the vaccinations in CFU/g or mL
n.d. = not determined

The absolute values for Bacillus subtilis determined in Table 12 are given below in Table 13 as log reduction levels.

TABLE 13
expressing the values indicated in Table
12 as log reduction (2nd batch)

| Time | Bacteria [CFU/mL] | Yeasts/Fungi [CFU/mL] |
|---|---|---|
| Start | 0.0 | n.d. |
| 15 h | 2.5 | n.d. |

n.d. = not determined

The probiotic in the form of Bacillus subtilis added to the aqueous liquid rehabilitation composition of Example 12 is stable over the whole disinfection time. It is reduced by 2.5 log levels after 15 h.

### b) Long-Term Test for 28 Days

The aim of the experiment was to determine how the rehabilitation composition according to the present invention affects the stability of an exemplary probiotic. For this purpose, the aqueous liquid rehabilitation composition was prepared and then the probiotic was added directly to the rehabilitation composition as a spore powder. The change in microbial content was determined by inoculation after the indicated time periods. At time 0 (start), the rehabilitation composition was inoculated with probiotic.

The rehabilitation composition of Example 12 was used. The probiotic added was Bacillus subtilis. The inoculation concentration was [log 10 CFU/g]: 10^{8.9}.

The same explanations as previously apply to the methods/(standard) method/deviations/more precise description.

The determined germ content values for Bacillus subtilis are summarised in Table 14 below:

TABLE 14

| Time | Bacteria [CFU/mL] | Yeasts/Fungi [CFU/mL] |
|---|---|---|
| Start | 730000000 | n.d. |

| | | | |
|---|---|---|---|
| 24 | h | 110000 | n.d. |
| 48 | h | 42000 | n.d. |
| 5 | d | 49000 | n.d. |
| 12 | d | 22000 | n.d. |
| 28 | d | 1600 | n.d. |

The figures are mean values of the inocculations in CFU/g or mL
n.d. = not determined

The absolute values for Bacillus subtilis indicated in Table 14 are given below in Table 15 as log reduction levels.

TABLE 15
expressing the values indicated in Table 14 as log reduction

| Time | Bacteria | Yeasts/Fungi |
|---|---|---|
| Start | 0.0 | n.d. |

| | | | |
|---|---|---|---|
| 24 | h | 3.9 | n.d. |
| 48 | h | 4.3 | n.d. |
| 5 | d | 4.2 | n.d. |
| 12 | d | 4.6 | n.d. |
| 28 | d | 5.7 | n.d. |

n.d. = not determined

The probiotic in the form of Bacillus subtilis added to the aqueous liquid rehabilitation composition of Example 12 is stable over the whole disinfection time. It is reduced by about 4 log levels after 24 h and this then remains almost constant for about 12 days.

Exemplary rehabilitation composition with: Bacillus lichenformis

### Long-Term Test for 28 Days

The procedure was the same as already explained, except that instead of the probiotic Bacillus subtilis, Bacillus lichenformis was present in the aqueous liquid rehabilitation composition according to the invention. The rehabilitation composition of Example 4 (Table 1A) was used wherein the probiotic added was Bacillus lichenformis. The inoculation concentration was [log 10 CFU/g]: 10^{8.0}.

The determined germ content values for Bacillus lichenformis are summarised in Table 16 below:

TABLE 16

| Time | Bacteria [CFU/mL] | Yeasts/Fungi [CFU/mL] |
|---|---|---|
| Start | 110000000 | n.d. |

| | | | |
|---|---|---|---|
| 24 | h | 25000000 | n.d. |
| 48 | h | 20000000 | n.d. |
| 5 | d | 15000000 | n.d. |
| 12 | d | 5100000 | n.d. |
| 28 | d | 410000 | n.d. |

The figures are mean values of the vaccinations in CFU/g or mL
n.d. = not determined

The absolute values for Bacillus lichenformis indicated in Table 16 are given below in Table 17 as log reduction levels.

TABLE 17
expressing the values indicated in Table 16 as log reduction

| Time | Bacteria | Yeasts/Fungi |
|---|---|---|
| Start | 0.0 | n.d. |

| | | | |
|---|---|---|---|
| 24 | h | 0.6 | n.d. |
| 48 | h | 0.7 | n.d. |
| 5 | d | 0.8 | n.d. |
| 12 | d | 1.3 | n.d. |
| 28 | d | 2.4 | n.d. |

n.d. = not determined

The probiotic in the form of Bacillus lichenformis present in the aqueous liquid rehabilitation composition (Example 12) is stable over the whole disinfection time. The probiotic in the form of Bacillus lichenformis undergoes virtually no or minimal degradation and is essentially retained for 12 days. It is particularly resistant.

Overall, it shows that a probiotic is stable in the aqueous composition at least during the time in which the rehabilitation composition is supposed to act and can thus also fully develop its positive efficacy.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present invention as come within known or customary practice in the art to which this invention pertains and which fall within the limits of the appended claims.

What is claimed is:

1. A rehabilitation composition, comprising or consisting of:
a micellar water comprising one or more non-ionic surfactants which are soluble or emulsifiable or dispersible in water;
one or more of a prebiotic, a probiotic, or a postbiotic;
one or more excipient solvents;
one or more excipient pH regulators, one or more excipient acids or their alkali and/or alkaline earth salts and/or amino acids giving the resulting composition a pH between 3 and 4.2;
up to 98.695% by weight of water;
wherein an aqueous liquid composition of the rehabilitation composition comprises the one or more non-ionic surfactants in an amount ranging from 1.0 to 5.0% by weight; and with the proviso that no surfactants (0.0% by weight) other than the non-ionic surfactants are present; the one or more solvents in an amount ranging from 0.1 to 20.0% by weight; and that no C1-C6 alcohols (0.0% by weight) other than a type of glycol ether are present; and no quaternary ammonium compounds are present.

2. The rehabilitation composition of claim 1, wherein an effect of the rehabilitating composition is that cleaning, solubilisation and protein denaturisation occurs without any requirements for personal protection equipment, or specialised recycling or handling.

3. The rehabilitation composition of claim 1, wherein the rehabilitation composition comprises one or more prebiotics selected from the group consisting of disaccharides, oligo- and polysaccharides, saccharose, lactose, maltose, trehalose, cellobiose, lactulose, cellulose, chitin, hemicelluloses, hexosans, pentosans, arabinoxylan, arabinogalactans, lignin, xanthan, lichenin, fructans, inulin, polyuronides, pectin, alginic acids and alginates, agar, carrageenan, raffinoses, polydextroses, glucan oligosaccharides, alpha- and beta-glucan oligosaccharides, galactooligosaccharides, trans-galactooligosaccharides, xylooligosaccharides, frutooligosaccharides, glucomannans, locust bean gum, guar, starch, high amylose starch, resistant starch, starch degradation products, dextrins, cyclodextrins, nerolidol (3,7,11-trimethyl-1,6,10-dodecatrien-3-ol) extract, xylitol, and combinations thereof.

4. The rehabilitation composition of claim 1, wherein the rehabilitation composition comprises one or more probiotics selected from the group consisting of strains of Micrococcaceae, strains of Alcaligenes, strains of Cyanobacteria, strains of Bacillus, strains of Bifidobacterium, strains of Clostridia, strains of Corynebacterium, strains of Enterococcus, strains of, strains of Lactobacillus, strains of Lactococcus, strains of Pedicoccus, strains of Propionibacterium, strains of Saccharomyces, strains of Neurospora, strains of Aspergillus and combinations thereof.

5. The rehabilitation composition of claim 4, wherein the one or more probiotics is selected from the group consisting of Bacillus licheniformis, Bacillus subtilis, Bacillus coagulans, Micrococcaceae luteus, Clostridium thermoaceticum, and combinations thereof.

6. The rehabilitation composition of claim 1, wherein the rehabilitation composition comprises one or more postbiotics selected from the group consisting of primary, secondary, and complex bacterial metabolites, bacterial lysates, bacterial ferments, a ferment of Bacillus, a ferment of Bacillus coagulans, Lactobacillus ferment, Lactobacillus lysate, Bifidobacterium lysate, and combinations thereof.

7. The rehabilitation composition of claim 1, wherein the aqueous liquid rehabilitation composition contains the one or more probiotics in a range of from 10³ to 10^{9.9} CFU/g; and/or
the aqueous liquid rehabilitation composition contains the one or more prebiotics and/or the one or more postbiotics in a range of from 0.005 to 5.0% by weight.

8. The rehabilitation composition of claim 1, wherein the one or more non-ionic surfactants are selected from the group consisting of fatty alcohol alkoxylates, polyalkylene glycol ethers, fatty alcohol propoxylates, fatty amine alkoxylates, fatty amine ethoxylates, fatty acid ethoxylates, fatty acid polyglycol esters, fatty acid polyglycol amides, polyglycerol esters, polyoxyethylene glycol alkylphenol esters, octylphenol ethoxylates, nonylphenol ethoxylates, alkanol amides, dodecyldimethylamine oxide, glycerol alkyl esters, sugar surfactants, alkyl glycosides, alkyl polyglucosides, alkyl polyglycosides, methyl glucoside esters, ethyl glucoside esters, N-methylglucamide, sucrose esters, and combinations thereof.

9. The rehabilitation composition of claim 1, wherein the one or more excipient solvents are present in an amount ranging from 0.1% to 20.0% by weight.

10. The rehabilitation composition of claim 1, wherein the one or more excipient solvents are selected from the group consisting of glycols with 2 to 10 carbons, butylene glycol, propylene glycol, 1,2-pentanediol, hexylene glycol, 1,2-octanediol, capric glycol 1,2-hexanediol, glycol ethers, diethylene glycol monomethyl ether, glycerine, and combinations thereof.

11. The rehabilitation composition of claim 1, wherein the one or more excipient solvents comprise 2-phenoxyethanol when another preservative is not present.

12. The rehabilitation composition of claim 1, wherein the rehabilitation composition comprises one or more excipient acids are amino, inorganic or organic acids selected from the group consisting of hydrochloric acid, sulphuric acid, phosphoric acid, malic acid, anic acid, indole acetic acid, formic acid, benzoic acid, succinic acid, acetic acid, fumaric acid, gentisic acid, methylglycinediacetic acid, ethylenediaminetetraacetic acid, fulvic acid, glutamic acid, glycine, cysteine, isovaleric acid, caffeic acid, maleic acid, malonic acid, mandelic acid, lactic acid, methionine, oxalic acid, propionic acid, salicylic acid, tartaric acid, tryptophan, a racemate of tartaric acid, cinnamic acid, citric acid, peracids, peracetic acid, peroctanoic acid, persorbic acid, perbenzoic acid, perpropionic acid, performic acid, perlactic acid, percitric acid, permalic acid, pertartaric acid, ascorbic acid, and combinations thereof.

13. The rehabilitation composition of claim 1, wherein the rehabilitation composition is an aqueous liquid composition comprising or consisting of:
selectively active or inactive excipient solvents between a pH of 3.2 and pH 4.2 in an amount of 0.1 to 2.9% by weight of the one or more acids or their alkali and/or alkaline earth salts thereof;
0.1 to 5.0% by weight of the one or more non-ionic surfactants;
0.005 to 5.0% by weight of the one or more prebiotic, postbiotic,
and/or probiotic in the range of from 103 to 109.9 CFU/g; and
a remaining balance by weight is water.

14. The rehabilitation composition of claim 1, wherein when excipients are selected from the groups characterised as generally regarded as safe for human skin in the amounts specified, the rehabilitation composition is an aqueous liquid composition comprising or consisting of:
0.1 to 3% by weight of the one or more acids or their alkali and/or alkaline earth salts thereof;
1.0 to 5.0% by weight of the one or more non-ionic surfactants;
0.005 to 5.0% by weight of the one or more prebiotic, postbiotic, and/or probiotic(s) in the range of from 103 to 109.9 CFU/g; and
a remaining balance by weight is water;

15. The rehabilitation composition of claim 1, wherein at least one of the one or more excipient acids is an amino acid known to break disulfide bonds in proteins, the rehabilitation composition being an aqueous liquid composition comprising or consisting of:
the one or more excipient solvents between a pH of 3.2 and pH of 3.6;
0.1 to 2.9% by weight of the one or more acids or their alkali and/or alkaline earth salts thereof;
0.1 to 5.0% by weight of the one or more non-ionic surfactants;
0.1 to 20.0% by weight of one or more moisture regulating agents comprising propylene glycol and/or diethylene glycol monomethyl ether;
0.005 to 5.0% by weight of the one or more prebiotic, postbiotic, and/or probiotic in the range of from 103 to 109.9 CFU/g; and
a remaining balance by weight is water.

16. A method of treating a surface with a rehabilitation composition, the method comprising:
applying the rehabilitation composition to the surface, the rehabilitation composition comprising or consisting of:
a micellar water comprising one or more non-ionic surfactants which are soluble or emulsifiable or dispersible in water;
one or more of a prebiotic, a probiotic, or a postbiotic;
one or more excipient solvents;
one or more excipient pH regulators, one or more excipient acids or their alkali and/or alkaline earth salts and/or amino acids giving the resulting composition a pH between 3 and 4.2;
up to 98.695% by weight of water;
wherein the rehabilitation composition comprises the one or more non-ionic surfactants in an amount ranging from 1.0 to 5.0% by weight; and with the proviso that no surfactants (0.0% by weight) other than the non-ionic surfactants are present; the one or more solvents in an amount ranging from 0.1 to 20.0% by weight; and that no C1-C6 alcohols (0.0% by weight) other than a type of glycol ether are present; and no quaternary ammonium compounds are present.

17. The method of claim 16, wherein the rehabilitation composition applied to the surface reduces an amount of not generally regarded as safe microorganisms on the surface.

18. The method of claim 16, wherein the surface is a skin surface of an animal, part of a plant, or a surface of an object contaminated with one or more pathogens.

19. The method of claim 16, wherein the rehabilitation composition is applied in the form of an aqueous composition, a solid composition, a foam, a gel, a creme, a spray, and/or a slurry.
